(19) United States
(12) Patent Application Publication
(10) Pub. No.: US 2024/0360276 A1
(43) Pub. Date: Oct. 31, 2024

(54) PROCESS FOR THE PREPARATION OF FUNCTIONALIZED TERPOLYMERS FROM EPOXIDES AND CARBON DIOXIDE

(71) Applicants: ENI S.P.A., Roma (IT); CONSIGLIO NAZIONALE DELLE RICERCHE, Roma (IT)

(72) Inventors: Paolo BIAGINI, Novara (IT); Riccardo PO', Novara (IT); Laura BOGGIONI, Abbiategrasso (MILANO) (IT); Simona LOSIO, Garbagnate Milanese (MI) (IT)

(21) Appl. No.: 18/559,941

(22) PCT Filed: May 10, 2022
(86) PCT No.: PCT/IB2022/054330

§ 371 Date: Nov. 9, 2023

(30) Foreign Application Priority Data
May 12, 2021 (IT) 102021000012149

(51) Int. Cl. C08G 64/34; C04B 24/28; C08G 64/02; C08G 64/42

(52) U.S. Cl. CPC C08G 64/34; C04B 24/286; C08G 64/0291; C08G 64/42

(57) ABSTRACT

A Process for the preparation of a functionalized terpolymer having general formula (I):

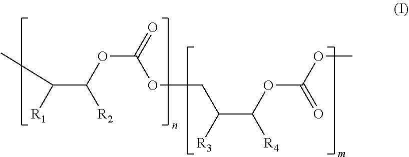

and including the following steps:
i) reacting at least one first epoxy compound having general formula (II):

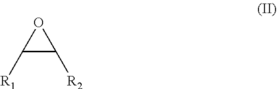

with at least a second epoxy compound having general formula (III):

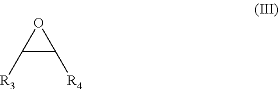

ii) reacting the terpolymer obtained in step i) with at least one sulphur-containing compound having general formula (IV):

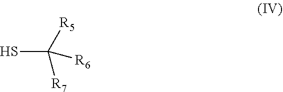

provided that in the general formula (IV) at least one of between R₅, R₆ and R₇ differs from hydrogen and at least one of between R₅, R₆ and R₇, contains one of the following functional groups: —COOH, —COO⁻M⁺, —SO₃H, —SO₃⁻M⁺, —SO₂H, —SO₂⁻M⁺, —OPO₃H₂, —OPO₃²⁻M⁺₂, —PO₃H₂, —PO₃²⁻M⁺₂, —OH,

The above process allows for terpolymers to be obtained which are soluble in polar solvents such as, for example, water, methanol, ethanol, butanol, acetone or dimethyl sulfoxide. The terpolymers can be advantageously used, for example, as additives for cements.

### CROSS-REFERENCE TO RELATED APPLICATIONS

This application is a 35 U.S.C. § 371 National Stage patent application of PCT/IB2022/054330 filed, on 10 May 2022, which claims the benefit of Italian patent application 102021000012149, filed on 12 May 2021, the disclosures of which are incorporated herein by reference in their entirety.

### TECHNICAL FIELD

The present disclosure relates to a process for the preparation of functionalized terpolymers from epoxides and carbon dioxide (CO₂).

More specifically, the present disclosure relates to a process for the preparation of a functionalized terpolymer comprising the following steps: i) reacting at least one first epoxy compound having the specific general formula (II) reported below with at least one second epoxy compound having the specific general formula (III) below, said at least one first epoxy compound having general formula (II) and said at least one second epoxy compound having general formula (III) being used in a specific molar ratio, and carbon dioxide (CO₂) in the presence of a catalytic system comprising at least one catalyst selected from complexes of a transition metal and, optionally, at least one co-catalyst selected from ionic compounds, thus obtaining a terpolymer and, subsequently, ii) reacting the terpolymer obtained in said step i) with at least one compound containing sulphur having the specific general formula (IV) reported below.

The above process allows to obtain terpolymers which are soluble in polar solvents such as, for example, water, methanol, ethanol, butanol, acetone or dimethyl sulfoxide. Said terpolymers can be advantageously used, for example, as additives for cements.

### BACKGROUND

It is known that aliphatic polycarbonates are biodegradable polymers mainly used in multilayer compositions for barrier films, as thickeners in the formulation of inks and in the production of objects. Their industrial interest also derives from the fact that aliphatic polycarbonates can be produced without using dangerous reagents such as, for example, phosgene, through a process that involves the copolymerization of an epoxy compound and carbon dioxide (CO₂): said process appears, therefore, to be “eco-friendly” and with a greater development prospect, especially for the use of carbon dioxide (CO₂) which is considered an easily available and low-cost component.

Since the 1960s, many researchers developed various types of catalytic systems suitable for preparing polycarbonates by alternating copolymerization between an epoxy compound and carbon dioxide (CO₂).

For example, Inoue S. et al., in “Journal of Polymer Science Part C: Polymer Letters” (1969), Vol. 7, Issue 4, pages 287-292, describe the use of a heterogeneous catalytic system, inadequately characterised and obtained by partial hydrolysis of diethyl zinc (ZnEt₂), in the copolymerization of an epoxy compound and carbon dioxide (CO₂). The catalyst thus obtained, however, has a very low activity, requiring a time of a few days to produce significant quantities of polycarbonate.

Aida T. et al., in “Journal of American Chemical Society” (1983), Vol. 105, pages 1304-1309, describe the use of aluminium porphyrins in order to activate carbon dioxide (CO₂) which is subsequently reacted with an epoxy compound. Also in this case, the catalytic activity is insufficient (<0.3 turnovers/h).

Darensbourg D. J. et al., in “Macromolecules” (1995), Vol. 28, pages 7577-7579, describe the use of some bulky phenoxides of zinc (II) in the copolymerization of an epoxy compound and carbon dioxide (CO₂), obtaining catalytic activities up to 2.4 turnovers/h.

Over the years, other researchers proposed the use of catalytic systems based on other transition metals and, specifically, the use of chromium (III) or cobalt (III) complexes.

For example, Holmes A. B. et al., in “Macromolecules” (2000), Vol. 33(2), pages 303-308, describe the use of specific chromium (III) porphyrins in the copolymerization of an epoxy compound and carbon dioxide (CO₂). In particular they describe the production of polycarbonates, specifically polycyclohexencarbonates with appreciable yields, varying around 50%-70% and with molecular weights that are not very high [i.e. having a number average molecular weight (Mₙ) between 1500 and 3900].

Chen X. et al., in “Polymer” (2009), Vol. 50, pages 441-446, describe the use of a series of chromium(III)/Schiff base N,N′-bis(salicylidene)-1,2-phenylediamino chromium(III) halides (e.g., [Cr(Salen)Cl]) for the production of polypropylene carbonate, with low yields (<50%) and unsatisfactory selectivity towards the formation of polypropylene oxide and/or cyclic carbonate, but with interesting molecular weights (number average molecular weight Mₙ of up to 25000). Similar results were obtained by Lu X. et al., in “Science China Chemistry” (2010), Vol. 53, pages 1646-1652, who describe the use of complexes based on Co(Salen)Cl in order to produce polypropylene carbonate with yields of around 50% and variable molecular weights (number average molecular weight Mₙ between 6500 and 30000).

Pescarmona P. P. et al., in the review “Journal of Applied Polymer Science” (2014), DOI:10.1002/APP.41141, effectively describe all the aspects inherent to the reaction between epoxides and carbon dioxide (CO₂) reporting the physical-chemical characterisation of the polymers obtained and their current potential field of application.

Recently, an attempt has been made to remedy the poor mechanical and chemical-physical properties of these materials, which limit their fields of application, through post-modification reactions on particular polycarbonates suitable for this purpose.

For example, Darensbourg D. J. et al., in “Macromolecules” (2014), Vol. 47, pages 3806-3813 (2014), describe the preparation of a series of copolymers obtained from 2-vinyloxirane and carbon dioxide (CO₂), the subsequent functionalization through post-modification with 2-mercaptoethanol or thioglycolic acid to obtain amphiphilic copolymers and the subsequent modification of said amphiphilic copolymers through, for example “ring-opening” with an anhydride salt of L-aspartic acid or deprotonation with an aqueous solution of ammonium hydroxide to obtain water-soluble copolymers.

Darensbourg D. J. et al., in “Polymer Chemistry” (2015), Vol. 6, pages 1768-1776, describe the preparation of a series of terpolymers obtained from propylene oxide, allyl glycidyl ether and carbon dioxide (CO₂) which are subsequently cross-linked in the presence of ethylene glycol bis(3-mercaptoproprionate) or pentaerythritol tetrakis(mercaptoacetate), obtaining new cross-linked materials with elastomeric characteristics.

Taherimehr M. et al., in “ChemSusChem” (2015), Vol. 8, pages 1034-1042 (2015), describe the use of a new pyridylamino-bis(phenolate) of iron as a catalyst for the conversion of carbon dioxide into cyclic carbonates and cross-linked polycarbonates. The specifically describe the cross-linking of poly(4-vinyl-1,2-cyclohexene carbonate) by reaction with 1,3-propan-dithiol, obtaining new cross-linked materials with improved thermal and mechanical properties.

Hauenstein O. et al., in “Nature Communications” (2016), DOI:10.1038/ncomms11862, describe the functionalization of poly(limonene carbonate) with a series of mercapto derivatives including: butyl-3-mercaptopropionate obtaining new polymeric materials with characteristics elastomeric; thioglycolic acid obtaining new polymeric materials with improved biodegradability; 2-(diethylamino) ethanthiol obtaining new polymeric materials with antibacterial properties.

Kori A. A. et al., in “RSC Advances” (2019), Vol. 9, pages 26542-26546, describe the copolymerization of vinylcyclohexene oxide with carbon dioxide (CO₂) in the presence of triphenylboron and the functionalization of the obtained copolymer in the presence of alkyl-aryl silanes in a single step.

### SUMMARY

From the above it is therefore evident the importance of finding new processes capable of modifying terpolymers deriving from epoxides and carbon dioxide (CO₂) by means of functionalization in order to be able to modulate their mechanical and chemical-physical properties according to the nature and amount of functionalizing compound used. It is equally clear that the transformation reaction of vinyl groups must have a high conversion so that there are no vinyl residues in the modified terpolymer that could accelerate their ageing. It is also clear that, as functionalizing compounds are expensive, in order to minimise their use, it is necessary to introduce the minimum amount of vinyl units in the initial terpolymer which, after transformation, are still able to provide the desired properties to the modified terpolymer.

The Applicant therefore posed the problem of finding a new process for obtaining terpolymers functionalized by epoxides and carbon dioxide (CO₂).

The Applicant has now found a process for the preparation of a functionalized terpolymer comprising the following steps: i) reacting at least one first epoxy compound having the general formula (II) reported below with at least one second epoxy compound having the general formula (III) reported below, said at least one first epoxy compound having general formula (II) and said at least one second epoxy compound having general formula (III) being used in a specific molar ratio and carbon dioxide (CO₂) in the presence of a system catalytic comprising at least one catalyst selected from complexes of a transition metal and, optionally, at least one co-catalyst selected from ionic compounds, thus obtaining a terpolymer and, subsequently, ii) reacting the terpolymer obtained in said step i) with at least one compound containing sulphur having the general formula (IV) reported below. Said process allows both to modulate the quantity of vinyl units present in the terpolymer, and to have a high functionalization of said vinyl units. Furthermore, said process allows to use low quantities of functionalizing compounds with a consequent saving in process costs. Furthermore, said process allows to obtain terpolymers which are soluble in polar solvents such as, for example, water, methanol, ethanol, butanol, acetone, dimethyl sulfoxide. Said terpolymers can be advantageously used, for example, as additives for cements.

Therefore, the purpose of the present disclosure is a process for the preparation of a functionalized terpolymer having general formula (I):

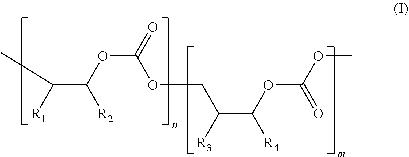

in which:
R₁ and R₂, the same or different from each other, represent a hydrogen atom; or they are selected from C₁-C₃₀ alkyl groups, preferably C₁-C₂₀, linear or branched, saturated, optionally containing heteroatoms, optionally substituted aryl groups, optionally substituted heteroaryl groups, optionally substituted cycloalkyl groups, optionally substituted heterocyclic groups;
or R₁ and R₂, can optionally be bonded together so as to form, together with the other atoms to which they are bonded, a cycle containing from 1 to 12 carbon atoms, saturated, optionally substituted with linear or branched C₁-C₂₀ alkyl groups, saturated, optionally containing heteroatoms, optionally substituted aryl groups, optionally substituted heteroaryl groups, optionally substituted cycloalkyl groups, optionally substituted heterocyclic groups, trialkyl- or triaryl-silyl groups, dialkyl- or diaryl-amino groups, dialkyl- or diaryl-phosphine groups C₁-C₂₀ alkoxy groups, preferably C₁-C₁₀, linear or branched, saturated, optionally substituted aryloxy groups, optionally substituted thioalkoxyl or thioaryloxy groups, cyano groups, said cycle optionally containing heteroatoms such as, for example, oxygen, sulphur, nitrogen, silicon, phosphorus or selenium, preferably oxygen or nitrogen;
R₃ and R₄, the same or different from each other, represent a hydrogen atom; or they are selected from C₁-C₃₀, alkyl groups, preferably C₁-C₂₀, linear or branched, saturated or unsaturated, optionally containing heteroatoms, optionally substituted aryl groups, optionally substituted heteroaryl groups, optionally substituted cycloalkyl groups, optionally substituted heterocyclic groups; provided that at least one of R₃ and R₄ is different from hydrogen and that at least one of R₃ and R₄ contains at least a double or a triple bond between two adjacent carbon atoms, and in the event that two or more double or triple bonds are present; said bonds can be conjugated or unconjugated, preferably unconjugated;
or R₃ and R₄, can optionally be bonded together so as to form, together with the other atoms to which they are bonded, a cycle containing from 1 to 12 carbon atoms, saturated or unsaturated, optionally substituted with linear C₁-C₂₀ alkyl groups or branched, saturated or unsaturated, optionally containing heteroatoms, optionally substituted aryl groups, optionally substituted heteroaryl groups, optionally substituted cycloalkyl groups, optionally substituted heterocyclic groups, trialkyl- or triaryl-silyl groups, dialkyl- or diaryl-amino groups or dialkyl- or diaryl-phosphine groups, C₁-C₂₀, alkoxyl groups, preferably C₁-C₁₀, linear or branched, saturated or unsaturated, optionally substituted aryloxy groups, optionally substituted thioalkoxyl or thioaryloxy groups, cyano groups, said cycle optionally containing heteroatoms such as, for example, oxygen, sulphur, nitrogen, silicon, phosphorus, selenium, preferably oxygen, nitrogen; provided that within the cycle or in any of its substitutions there is at least a double or a triple bond between two adjacent carbon atoms, and in the event that two or more double or triple bonds are present, said bonds can be conjugated or unconjugated, preferably unconjugated;
n and m, equal to or different from each other, are an integer between 1 and 5000, preferably between 1 and 3000, provided that n+m is greater than or equal to 5; comprising the following steps:
i) reacting at least one first epoxy compound having general formula (II):

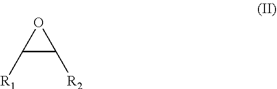

in which R₁ and R₂ have the same meanings reported above;
with at least one second epoxy compound having general formula (III):

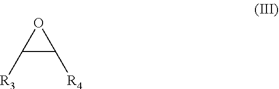

in which R₃ and R₄ have the same meanings reported above;
and carbon dioxide (CO₂), in the presence of a catalytic system comprising at least one catalyst selected from complexes of a transition metal and, optionally, at least one co-catalyst selected from ionic compounds;
in which said at least one first epoxy compound having general formula (II) and said at least one second epoxy compound having general formula (III) are used in a molar ratio between 1:99 and 99:1, thus obtaining a terpolymer;
ii) reacting the terpolymer obtained in said step i) with at least one sulphur-containing compound having general formula (IV):

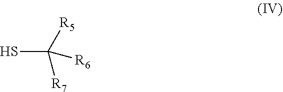

in which R₅, R₆ and R₇, the same or different from each other, represent a hydrogen atom; or they are selected from C₁-C₂₀ alkyl groups, preferably C₁-C₁₂, linear or branched, saturated or unsaturated, optionally containing heteroatoms, optionally substituted aryl groups, optionally substituted heteroaryl groups, optionally substituted cycloalkyl groups, optionally substituted heterocyclic groups;
provided that in said general formula (IV) at least one of between R₅, R₆ and R₇ differs from hydrogen and at least one of between R₅, R₆ and R₇, contains one of the following functional groups: —COOH, —COO⁻M⁺, —SO₃H, —SO₃⁻M⁺, —SO₂H, —SO₂⁻M⁺, —OPO₃H₂, —OPO₃²⁻M⁺₂, —PO₃H₂, —PO₃²⁻M⁺₂, —OH, in which M⁺ represents a monovalent inorganic cation such as, for example, cesium (Cs⁺), rubidium (Rb⁺), potassium (K⁺), lithium (Li⁺), sodium (Na⁺), copper (Cu⁺), silver (Ag⁺), ammonium (NH₄⁺) or mixtures thereof; or M⁺ represents a monovalent organic cation such as, for example, methylammonium (CH₃NH₃⁺), n-butylammonium (C₄H₁₂N⁺), ethanolammonium (C₂H₅ONH₃⁺, diethanolammonium (C₄H₁₀O₂NH₂⁺), triethanolammonium (C₆H₁₅O₃NH⁺), pyridinium (C₅H₅NH⁺), monohydroxypyridinium (C₅H₅ONH⁺), dihydroxypyridinium (C₅H₅NO₂H⁺) or mixtures thereof; preferably M⁺ is selected from between potassium (K⁺), sodium (Na⁺), ammonium (NH₄⁺) or, more preferably, ammonium is (NH₄⁺).

For the purpose of the present description and of the following claims, the definitions of the numerical ranges always include the extremes, unless otherwise specified.

For purposes of the present description and of the following claims, the term “comprising” also includes the terms “which essentially consists of” or “which consists of”.

For the purpose of the present description and of the following claims, the terms “C₁-C₃₀ alkyl groups” and “C₁-C₂₀ alkyl groups” refer to alkyl groups having from 1 to 30 carbon atoms or from 1 to 20 carbon atoms, respectively, linear or branched, saturated or unsaturated. Specific examples of C₁-C₃₀ alkyl groups and C₁-C₂₀ alkyl groups are: methyl, ethyl, n-propyl, iso-propyl, n-butyl, iso-butyl, tert-butyl, pentyl, hexyl, heptyl, octyl, 2-ethylheptyl, 2-ethylhexyl, 2-butenyl, 2-pentenyl, 2-ethyl-3-hexenyl, 3-octenyl, 1-methyl-4-hexenyl, 2-butyl-3-hexenyl.

For the purpose of the present description and of the following claims, the terms “C₁-C₃₀ alkyl groups optionally containing heteroatoms” and “C₁-C₂₀ alkyl groups optionally containing heteroatoms” refer to alkyl groups having from 1 to 30 carbon atoms or from 1 to 20 carbon atom, respectively, linear or branched, saturated or unsaturated, in which at least one of the hydrogen atoms is substituted with a heteroatom selected from halogens such as, for example, fluorine, chlorine, bromine, preferably fluorine; nitrogen; sulphur; oxygen. Specific examples of C₁-C₃₀ and C₁-C₂₀ alkyl groups optionally containing heteroatoms are: fluoromethyl, difluoromethyl, trifluoromethyl, trichloromethyl, 2,2,2-trifluoroethyl, 2,2,2-trichlororoethyl, 2,2,3,3-tetrafluoropropyl, 2,2,3,3,3-pentafluoropropyl, perfluoropentyl, perfluorooctyl, perfluorodecyl, ethyl-2-methoxy, propyl-3-ethoxy, butyl-2-thiomethoxy, hexyl-4-amino, hexyl-3-N,N′-dimethylamine, methyl-N,N′-dioctylamino, 2-methyl-hexyl-4-amino.

For the purpose of the present description and of the following claims, the term “aryl groups” refers to aromatic carbocyclic groups containing from 6 to 60 carbon atoms. Said aryl groups can optionally be substituted with one or more groups, the same or different from each other, selected from: halogen atoms such as, for example, fluorine, chlorine, bromine, preferably fluorine; hydroxyl groups; C₁-C₁₂ alkyl groups; C₁-C₁₂ alkoxy groups; C₁-C₁₂ thioalkoxyl groups; C₃-C₂₄ polyethylene oxyl groups; cyano groups; amino groups; C₁-C₁₂; mono- or di-alkylamine groups; nitro groups. Specific examples of aryl groups are: phenyl, methylphenyl, trimethylphenyl, methoxyphenyl, hydroxyphenyl, phenyloxyphenyl, fluorophenyl, pentafluorophenyl, chlorophenyl, bromophenyl, nitrophenyl, dimethylaminophenyl, naphthyl, phenylnaphthyl, phenanthrene, anthracene.

For the purpose of the present description and of the following claims, the term “heteroaryl groups” refers to aromatic, penta- or hexa-atomic heterocyclic groups, including benzocondensed or heterobicyclic, containing from 4 to 60 carbon atoms and from 1 to 4 heteroatoms selected from between nitrogen, oxygen, sulphur, silicon, selenium or phosphorus. Said cycloalkyl groups can optionally be substituted with one or more groups, the same or different from each other, selected from: halogen atoms such as, for example, fluorine, chlorine or bromine, preferably fluorine; hydroxyl groups; C₁-C₁₂ alkyl groups; C₁-C₁₂ alkoxy groups; C₁-C₁₂ thioalkoxyl groups; C₃-C₂₄ tri-alkylsilyl groups; polyethylene oxyl groups; cyano groups; amino groups; C₁-C₁₂; mono- or di-alkylamine groups; nitro groups. Specific examples of heteroaryl groups are: pyridine, methylpyridine, methoxypyridine, phenylpyridine, fluoropyridine, pyrimidine, pyridazine, pyrazine, triazine, tetrazine, quinoline, quinoxaline, quinazoline, furan, thiophene, hexylthiophene, bromothiphene, dibromothiphene, pyrrole, oxazole, thiazole, isoxazole, isothiazole, oxadiazole, thiadiazole, pyrazole, imidazole, triazole, tetrazole, indole, benzofuran, benzothiophene, benzooxazole, benzothiazole, benzooxadiazole, benzothiadiazole, benzopyrazole, benzimidazole, benzotriazole, triazolopyridine, triazolopyrimidine, coumarin.

For the purpose of the present description and of the following claims, the term “cycloalkyl groups” refers to cycloalkyl groups having from 3 to 60 carbon atoms. Said cycloalkyl groups can optionally be substituted with one or more groups, the same or different from each other, selected from: halogen atoms such as, for example, fluorine, chlorine, bromine, preferably fluorine; hydroxyl groups; C₁-C₁₂ alkyl groups; C₁-C₁₂ alkoxy groups; C₁-C₁₂ thioalkoxyl groups; C₃-C₂₄ tri-alkylsilyl groups; polyethylene oxyl groups; cyano groups; amino groups C₁-C₁₂; mono- or di-alkylamine groups; nitro groups. Specific examples of cycloalkyl groups are: cyclopropyl, 2,2-difluorocyclopropyl, cyclobutyl, cyclopentyl, cyclohexyl, methylcyclohexyl, methoxycyclohexyl, fluorocyclohexyl, phenylcyclohexyl, decalin, abietyl.

For the purpose of the present description and of the following claims, the term “heterocyclic groups” refers to rings having from 3 to 12 atoms, saturated or unsaturated, containing at least one heteroatom selected from nitrogen, oxygen, sulphur, silicon, selenium, phosphorus, optionally condensed with other aromatic or non-aromatic rings. Said heterocyclic groups can optionally be substituted with one or more groups, the same or different from each other, selected from: halogen atoms such as, for example, fluorine, chlorine, bromine, preferably fluorine; hydroxyl groups C₁-C₁₂ alkyl groups; C₁-C₁₂ alkoxy groups; C₁-C₁₂ thioalkoxyl groups; C₃-C₂₄; tri-alkylsilyl groups; polyethylene oxyl groups; cyano groups; amino groups; C₁-C₁₂; mono- or di-alkylamine groups; nitro groups. Specific examples of heterocyclic groups are: pyrrolidine, methoxypyrrolidine, piperidine, fluoropiperidine, methylpiperidine, dihydropyridine, piperazine, morpholine, thiazine, indoline, phenylindoline, 2-ketoazetidine, diketopiperazine, tetrahydrofuran, tetrahydrothiophene.

For the purpose of the present description and of the following claims, the term “cycle” refers to a system containing a ring containing from 2 to 12 carbon atoms, saturated or unsaturated, optionally containing heteroatoms selected from nitrogen, oxygen, sulphur, silicon, selenium, phosphorus. Specific examples of cycles are: toluene, benzonitrile, cycloheptatriene, cyclooctadiene, pyridine, piperidine, tetrahydrofuran, thiadiazole, pyrrole, thiophene, selenophen, tert-butylpyridine.

For the purpose of the present description and of the following claims, the term “trialkyl- or triaryl-silyl groups” refers to groups comprising a silicon atom to which three C₁-C₁₂ alkyl groups, or three C₆-C₂₄, aryl groups, or a combination thereof are bound. Specific examples of trialkyl- or triaryl-silyl groups are: trimethylsilane, triethylsilane, trihexylsilane, tridodecylsilane, dimethyldodecylsilane, triphenylsilane, methyldiphenylsilane, dimethylnaphthylsilane.

For the purpose of the present description and of the following claims, the term “dialkyl- or diaryl-amino groups” refers to groups comprising a nitrogen atom to which two C₁-C₁₂ alkyl groups, or two C₆-C₂₄ aryl groups, or a combination thereof are bound Specific examples of dialkyl- or diaryl-amino groups are: dimethylamine, diethylamine, dibutylamine, diisobutylamine, diphenylamine, methylphenylamine, dibenzylamine, ditolylamine, dinaphthylamine.

For the purpose of the present description and of the following claims, the term “dialkyl- or diaryl-phosphine groups” refers to groups comprising a phosphorus atom to which two C₁-C₁₂ alkyl groups, or two C₆-C₂₄ aryl groups, or a combination thereof, are bound. Specific examples of dialkyl- or diaryl-phosphine groups are: dimethylphosphine, diethylphosphine, dibutylphosphine, diphenylphosphine, methylphenylphosphine, dinaphthylphosphine.

For the purpose of the present description and of the following claims, the term “C₁-C₂₀ alkoxyl groups” refers to groups comprising an oxygen atom to which a C₁-C₂₀ alkyl group, linear or branched, saturated or unsaturated, is bound. Specific examples of C₁-C₂₀alkoxy groups are: methoxy, ethoxy, n-propoxy, iso-propoxy, n-butoxy, iso-butoxy, tert-butoxy, pentoxyl, hexyloxy, heptyloxy, octyloxy, nonyloxy, decyloxy, dodecyloxy.

For the purpose of the present description and of the following claims, the term “aryloxy groups” refers to groups comprising an oxygen atom to which a C₆-C₂₄ aryl group is bound. Said aryloxy groups can optionally be substituted with one or more groups, the same or different from each other, selected from: halogen atoms such as, for example, fluorine, chlorine, bromine, preferably fluorine; hydroxyl groups C₁-C₁₂ alkyl groups; C₁-C₁₂ alkoxy groups; C₁-C₁₂ thioalkoxyl groups; C₃-C₂₄; tri-alkylsilyl groups; cyano groups; amino groups C₁-C₁₂; mono- or di-alkylamine groups; nitro groups. Specific examples of aryloxy groups are: phenoxy, para-methylphenoxy, para-fluorophenoxy, orto-butylphenoxy, naphthyloxy, anthracenoxy.

For the purpose of the present description and of the following claims, the term “thioalkoxy or thioaryloxy groups” refers to groups comprising a sulphur atom to which a C₁-C₁₂ alkoxy group or a C₆-C₂₄ aryloxy group is bonded. Said thioalkoxy or thioaryloxy groups can optionally be substituted with one or more groups, the same or different from each other, selected from between: halogen atoms such as, for example, fluorine, chlorine, bromine, preferably fluorine; hydroxyl groups; C₁-C₁₂ alkyl groups; C₁-C₁₂ alkoxy groups; C₁-C₁₂ thioalkoxy groups; C₃-C₂₄ tri-alkylsilyl groups; cyano groups; amino groups; C₁-C₁₂; mono- or di-alkylamine groups; nitro groups. Specific examples of thioalkoxy or thioaryloxy groups are: thiomethoxy, thioethoxyl, thiopropoxy, thiobutoxy, thio-iso-butoxy, 2-ethylthiohexiloxyl, thiophenoxy, para-methylthiophenoxy, para-fluorothiophenoxyl, orto-butylthiophenoxy, naphthylthiooxyl, anthracenylthiooxyl.

### DETAILED DESCRIPTION OF THE DISCLOSURE

In accordance with a preferred embodiment of the present disclosure, said catalytic system can comprise:
(a) at least one catalyst selected from complexes of a transition metal having general formula (V):

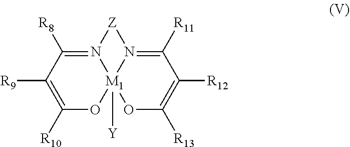

in which:
   M₁ represents a metal atom selected from between chromium, manganese, iron, cobalt, nickel or aluminium, preferably chromium or cobalt;
   R₈, R₉, R₁₀, R₁₁, R₁₂ and R₁₃, the same or different from each other, represent a hydrogen atom; or are selected from C₁-C₂₀ alkyl groups, preferably C₁-C₁₂, linear or branched, saturated or unsaturated, optionally containing heteroatoms; optionally substituted aryl groups; optionally substituted heteroaryl groups; optionally substituted cycloalkyl groups; optionally substituted heterocyclic groups;
   or R₉ and R₁₀ and/or R₁₂ and R₁₃, can optionally be bonded together so as to form, together with the other atoms to which they are bonded, a cycle containing from 2 to 12 carbon atoms, saturated, unsaturated, or aromatic optionally substituted with linear or branched, saturated or unsaturated C₁-C₂₀ alkyl groups, optionally containing heteroatoms, optionally substituted aryl groups, optionally substituted heteroaryl groups, optionally substituted cycloalkyl groups, optionally substituted heterocyclic groups, trialkyl- or triaryl-silyl groups dialkyl or diaryl-amino, dialkyl- or diaryl-phosphine groups, C₁-C₂₀ alkoxyl groups, preferably C₂-C₁₀, linear or branched, saturated or unsaturated, optionally substituted aryloxy groups, optionally substituted thioalkoxyl or thioaryloxy groups, cyano groups, said cycle optionally containing heteroatoms such as, for example, oxygen, sulphur, nitrogen, silicon, phosphorus or selenium, preferably oxygen or nitrogen;
   Y represents a halide anion such as, for example, a fluoride anion, a chloride anion, a bromide anion, an iodide anion, preferably a chloride anion, a bromide anion; or it is selected from inorganic anions such as, for example, azide anion, hydroxide anion, amide anion, perchlorate anion, chlorate anion, sulphate anion, phosphate anion, nitrate anion, preferably an azide anion; or it is selected from organic anions such as, for example C₁-C₂₀ alcoholate anion, C₁-C₂₀ thioalcoholate anion, C₁-C₃₀ carboxylate anion, C₁-C₃₀ alkyl- or dialkyl-amide anion;
      Z represents a divalent organic radical having general formula (VI), (VII) or (VIII):

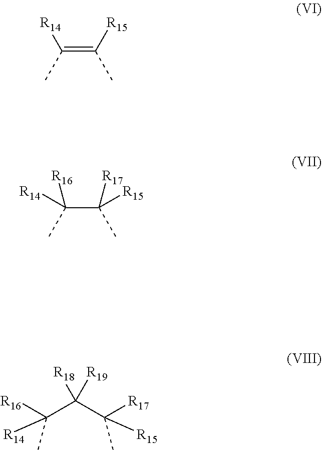

in which:
R₁₄, R₁₅, R₁₆, R₁₇, R₁₈ and R₁₉, the same or different from each other, represent a hydrogen atom; or they are selected from C₁-C₂₀ alkyl groups, preferably C₁-C₁₂, linear or branched, saturated or unsaturated, optionally containing heteroatoms; optionally substituted aryl groups; optionally substituted heteroaryl groups; optionally substituted cycloalkyl groups; optionally substituted heterocyclic groups;
or R₁₄ and R₁₅ in the general formula (VI), or R₁₅ and R₁₆ or R₁₆ and R₁₇ in the general formula (VII), or R₁₄ and R₁₈ or R₁₄ and R₁₉ or R₁₇ and R₁₉ or R₁₈ and R₁₇ in the general formula (VIII), they can optionally be bonded together so as to form, together with the other atoms to which they are bonded, a cycle containing from 2 to 12 carbon atoms, saturated, unsaturated, or aromatic, optionally substituted with linear or branched C₁-C₂₀ alkyl groups, saturated or unsaturated, optionally containing heteroatoms, optionally substituted aryl groups, optionally substituted heteroaryl groups, optionally substituted cycloalkyl groups, optionally substituted heterocyclic groups, trialkyl- or triaryl-silyl groups, dialkyl- or diaryl-amino groups, dialkyl- or diaryl-phosphine-groups, C₁-C₂₀ alkoxy groups, preferably C₂-C₁₀, linear or branched, saturated or unsaturated, optionally substituted aryloxy groups, optionally substituted thioalkoxyl or thioaryloxy groups, cyano groups, said cycle optionally containing heteroatoms such as, for example, oxygen, sulphur, nitrogen, silicon, phosphorus or selenium or, preferably, oxygen or nitrogen;
(b) at least one co-catalyst selected from ionic compounds having general formula (IX):

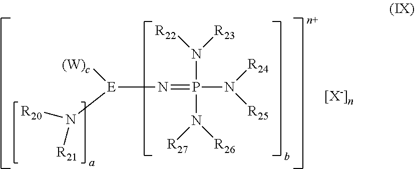

in which:
   E represents an atom selected from between phosphorus, arsenic, antimony or bismuth, preferably phosphorus;
   R₂₀, R₂₁, R₂₂, R₂₃, R₂₄, R₂₅, R₂₆ and R₂₇, the same or different from each other, represent a hydrogen atom; or they are selected from between C₁-C₂₀ alkyl groups, preferably C₁-C₁₂, linear or branched, saturated or unsaturated, optionally containing heteroatoms, optionally substituted aryl groups, optionally substituted heteroaryl groups, said optionally substituted heteroaryl groups being optionally in cationic form, cycloalkyl groups optionally substituted, optionally substituted heterocyclic groups, said optionally substituted heterocyclic groups being optionally in cationic form, trialkyl- or triaryl-silyl groups;
   or R₂₀ and R₂₁, and/or R₂₂ and R₂₃, or R₂₃ and R₂₄, or R₂₄ and R₂₅, and/or R₂₆ and R₂₇, can optionally be bonded together so as to form, together with the other atoms to which they are bonded, a cycle containing from 2 to 12 carbon atoms, saturated, unsaturated, or aromatic, optionally substituted with linear or branched C₁-C₂₀ alkyl groups, saturated or unsaturated, optionally containing heteroatoms, optionally substituted aryl groups, optionally substituted heteroaryl groups, optionally cycloalkyl groups substituted, optionally substituted heterocyclic groups, trialkyl- or triaryl-silyl groups, dialkyl- or diaryl-amino groups, dialkyl- or diaryl-phosphine groups C₁-C₂₀ alkoxy groups, preferably C₂-C₁₀, linear or branched, saturated or unsaturated, optionally substituted aryloxy groups, optionally substituted thioalkoxyl or thioaryloxy groups, cyano groups, said cycle optionally containing heteroatoms such as, for example, oxygen, sulphur, nitrogen, silicon, phosphorus or selenium, preferably oxygen or nitrogen;
   W represents a halogen atom such as, for example, chlorine, bromine, fluorine, iodine, preferably chlorine, bromine; or it is selected from between C₁-C₂₀ alkoxy groups, preferably C₂-C₁₀, linear or branched, saturated or unsaturated, optionally substituted aryloxy groups, oxylamino groups;
   X⁻ represents a halide anion such as, for example, a fluoride anion, a chloride anion, a bromide anion, an iodide anion, preferably a chloride anion, a bromide anion; or it is selected from inorganic anions such as, for example, azide anion, perchlorate anion, chlorate anion, sulphate anion, phosphate anion, nitrate anion, hexafluorophosphate anion, tetrafluoroborate anion; or it is selected from organic anions such as, for example, benzenesulfonate anion, toluenesulfonate anion, dodecylsulfate anion, octylphosphate anion, dodecylphosphate anion, octadecylphosphate anion, phenylphosphate anion; or it is selected from tetraalkylborate anions optionally containing heteroatoms such as, for example, oxygen, sulphur, nitrogen, silicon, phosphorus or selenium, preferably oxygen or nitrogen; tetraarylborate anions optionally containing heteroatoms such as, for example, oxygen, sulphur, nitrogen, silicon, phosphorus or selenium, preferably oxygen, nitrogen; preferably a chloride anion or an azide anion;
a is an integer between 0 and 4, preferably between 1 and 3;
b is an integer between 0 and 4, preferably between 1 and 4;
c is 0 or 1, preferably 0;
provided that the sum of a+b+c is equal to 4 and that at least either a or b is not 0;
n is an integer between 1 and 4, preferably 1 or 2.

Further details relating to said catalytic system comprising at least one catalyst (a) and at least one co-catalyst (b) can be found in the international patent application WO 2020/079573 under the name of the Applicants, the content of which is incorporated herein as reference.

In accordance with a further preferred embodiment of the present disclosure, said catalytic system can comprise:
(c) at least one catalyst selected from complexes of a transition metal having general formula (V):

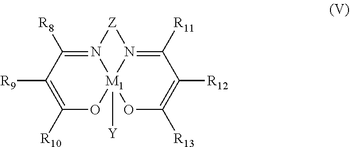

in which R₈, R₉, R₁₀, R₁₁, R₁₂, R₁₃, M₁, Z and Y, have the same meanings reported above;
(d) at least one co-catalyst selected from ionic compounds having general formula (X):

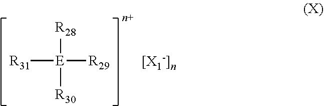

in which:
   E represents a metal atom selected from between phosphorus, arsenic, antimony or bismuth, preferably phosphorus;
   R₂₈, R₂₉, R₃₀ and R₃₁, the same or different from each other, represent a hydrogen atom; or they represent a halogen atom such as, for example, fluorine, chlorine, bromine, preferably fluorine or bromine; or they are selected from C₁-C₂₀ alkyl groups, preferably C₁-C₁₂, linear or branched, saturated or unsaturated, optionally containing heteroatoms, optionally substituted aryl groups, optionally substituted heteroaryl groups, said optionally substituted heteroaryl groups being optionally in cationic form, cycloalkyl groups optionally substituted, optionally substituted heterocyclic groups, said optionally substituted heterocyclic groups being optionally in cationic form;
   or R₂₈ and R₂₉, or R₂₉ and R₃₀, or R₃₀ and R₃₁, or R₃₁ and R₂₈ can optionally be bonded together so as to form, together with the other atoms to which they are bonded, a cycle containing from 1 to 12 carbon atoms, saturated, unsaturated, or aromatic, optionally substituted with linear or branched C₁-C₂₀ alkyl groups, saturated or unsaturated, optionally containing heteroatoms, optionally substituted aryl groups, optionally substituted heteroaryl groups, optionally substituted cycloalkyl groups, optionally substituted heterocyclic groups, trialkyl- or triaryl-silyl groups, dialkyl- or diaryl-amino groups, dialkyl- or diaryl-phosphine groups, C₁-C₂₀ alkoxy groups, preferably C₂-C₁₀, linear or branched, saturated or unsaturated, optionally substituted aryloxyl groups, thioalkoxyl or thioaryloxy groups optionally substituted, cyano groups, said cycle optionally containing heteroatoms such as, for example, oxygen, sulphur, nitrogen, silicon, phosphorus or selenium, preferably oxygen or nitrogen;
   X₁⁻ represents a halide anion such as, for example, a fluoride anion, a chloride anion, a bromide anion, an iodide anion, preferably a chloride anion or a bromide anion; or it is selected from inorganic anions such as, for example, azide anion, perchlorate anion, chlorate anion, sulphate anion, phosphate anion, nitrate anion, hexafluorophosphate anion or tetrafluoroborate anion; or it is selected from organic anions such as, for example, benzenesulfonate anion, toluenesulfonate anion, dodecylsulfate anion, octylphosphate anion, dodecylphosphate anion, octadecylphosphate anion, phenylphosphate anion or tetraphenylborate anion; preferably a chloride anion, a bromide anion, an azide anion, a tetrafluoroborate anion or a sulphate anion;
      provided that at least three of between R₂₈, R₂₉, R₃₀ and R₃₁, are not hydrogen.

Further details relating to said catalytic system comprising at least one catalyst (c) and at least one co-catalyst (d) can be found in the international patent application WO 2019/092266 under the name of the Applicants, the content of which is incorporated herein as reference.

In accordance with a further preferred embodiment of the present disclosure, said catalytic system can comprise:
(e) at least one catalyst selected from complexes of a transition metal having general formula (XI):

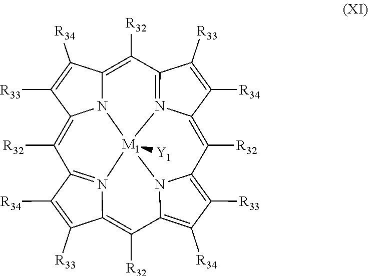

in which:
M₁ represents a metal atom selected from between chromium, manganese, iron, cobalt, nickel or aluminium, preferably chromium or cobalt;
Y₁ represents a halide anion such as, for example, a fluoride anion, a chloride anion, a bromide anion, an iodide anion; or it is selected from inorganic anions such as, for example, azide anion, hydroxide anion, amide anion, perchlorate anion, chlorate anion, sulphate anion, phosphate anion or nitrate anion; or it is selected from organic anions such as, for example, C₁-C₃₀ carboxylated anions such as, for example, acetate anion, butyrate anion, 2-ethyl-hexanoate anion, acrylate anion, methyl methacrylate anion, benzoate anion or trifluoroacetate anion, C₁-C₂₀ alcoholate anions such as, for example, methoxide anion, ethoxide anion, tert-butoxide anion, phenoxide anion, 2,4,6-trimethylphenoxide anion, 4-tert-butylphenoxide anion, C₁-C₂₀ thioalcholate anions, such as, for example, thioethoxide anion, thiophenoxide anion, C₁-C₃₀ alkyl- or dialkyl-amides anions such as, for example, di-methyl-amide anion, di-iso-propylamide anion or di-phenyl-amide anion; preferably a chloride anion, a bromide anion or an azide anion;
R₃₂ represents a hydrogen atom; or it is selected from C₁-C₂₀ alkyl groups, preferably C₁-C₁₂, linear or branched, saturated or unsaturated, optionally containing heteroatoms, optionally substituted aryl groups, optionally substituted heteroaryl groups, said optionally substituted heteroaryl groups being optionally in cationic form, cycloalkyl groups optionally substituted, optionally substituted heterocyclic groups, said optionally substituted heterocyclic groups being optionally in cationic form;
R₃₃ and R₃₄, the same or different from each other, represent a hydrogen atom; or they are selected from C₁-C₂₀ alkyl groups, preferably C₁-C₁₂, linear or branched, saturated or unsaturated alkyl groups, optionally containing heteroatoms, optionally substituted aryl groups, optionally substituted heteroaryl groups, optionally substituted cycloalkyl groups, optionally substituted heterocyclic groups, optionally substitutes trialkyl or triaryl silyl groups;
or R₃₃ and R₃₄, can optionally be bonded together so as to form, together with the atoms to which they are bonded, a cycle containing from 3 to 12 carbon atoms, saturated, unsaturated or aromatic, optionally polycondensed, optionally substituted with linear or branched C₁-C₂₀ alkyl groups, saturated or unsaturated, optionally containing heteroatoms, optionally substituted aryl groups, optionally substituted heteroaryl groups, optionally substituted cycloalkyl groups, optionally substituted heterocyclic groups, trialkyl- or triaryl-silyl groups, dialkyl- or diaryl-amino groups, C₁-C₂₀ alkoxy groups, preferably C₂-C₁₀, linear or branched, saturated or unsaturated, optionally substituted aryloxy groups, optionally substituted thioalkoxyl or thioaryloxy groups, cyano groups, said cycle optionally containing heteroatoms such as, for example, oxygen, sulphur, nitrogen, silicon, phosphorus or selenium, preferably oxygen or nitrogen;
   (f) at least one co-catalyst selected from:
   (g) ionic compounds having general formula (X):

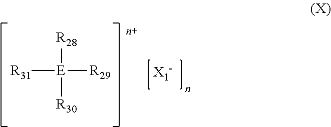

in which R₂₈, R₂₉, R₃₀, R₃₁, E and X₁⁻, have the meanings reported above;
(h) ionic compounds having general formula (IX):

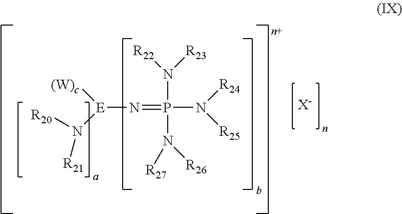

in which E, W, R₂₀, R₂₁, R₂₂, R₂₃, R₂₄, R₂₅, R₂₆, R₂₇, X⁻, a, b, c and n have the meanings reported above.

Further details relating to said catalytic system comprising at least one catalyst (e) and at least one co-catalyst (f) selected from between (g) and (h) can be found in the Italian patent application MI102019000006590, the content of which is incorporated herein as reference.

In accordance with a preferred embodiment of the present disclosure, said first epoxy compound having general formula (II) can be selected, for example, from C₂-C₂₀ alkylene oxides, optionally substituted with one or more halogen atoms or with one or more alkoxy groups; cycloalkylene oxides C₆-C₂₀, optionally substituted with one or more halogen atoms or with one or more alkoxy groups; C₈-C₂₀ styrene oxides, optionally substituted with one or more halogen atoms or with one or more alkoxy, alkyl or aryl groups.

In accordance with a further preferred embodiment of the present disclosure, said first epoxy compound having general formula (II) can be selected, for example, from between ethylene oxide, propylene oxide, butene oxide, pentene oxide, hexene oxide, octene oxide, decene oxide, dodecene oxide, tetradecene oxide, hexadecene oxide, octadecene oxide, epifluorohydrin, epichlorohydrin, epibromhydrin, iso-propyl glycidyl ether, butyl glycidyl ether, tert-butyl glycidyl ether, 2-ethylhexyl glycidyl ether, cyclopentene oxide, cyclododecene oxide, α-pinene oxide, 2,3-epoxynorbornane, 2,3-epoxypropylbenzene, styrene oxide, phenylpropylene oxide, stilbene oxide, chlorostilbene oxide, dichlorostilbene oxide, 1,2-epoxy-3-phenoxypropane, benzyloxymethyl oxirane, glycidyl-methylphenyl ether, chlorophenyl-2,3-epoxypropyl ether, epoxypropyl methoxyphenyl ether, biphenyl glycidyl ether, glycidyl naphthyl ether, or mixtures thereof. Cyclohexene oxide, propylene oxide and ethylene oxide are preferred.

In accordance with a preferred embodiment of the present disclosure, said second epoxy compound having general formula (III) can be selected, for example, from amongst the compounds reported in Table 1.

TABLE 1

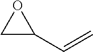

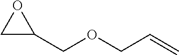

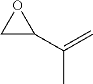

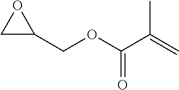

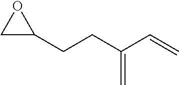

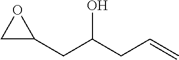

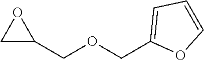 [SMILES: c1coc(COCC2CO2)c1]

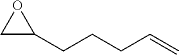

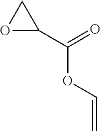

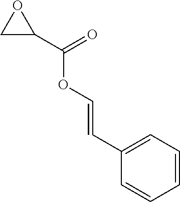 [SMILES: O=C(O/C=C/c1ccccc1)C1CO1]

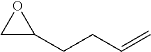

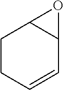

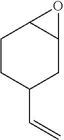

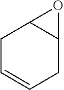

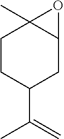

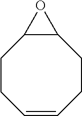

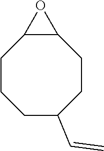

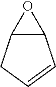

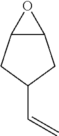

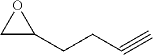

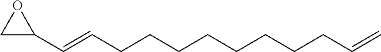

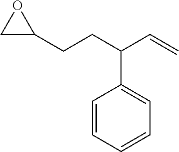

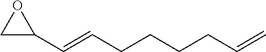

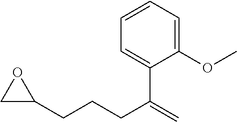 [SMILES: C=C(CCCC1CO1)c1ccccc1OC]

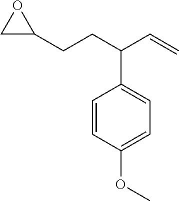 [SMILES: C=CC(CCC1CO1)c1ccc(OC)cc1]

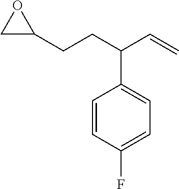

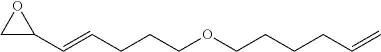

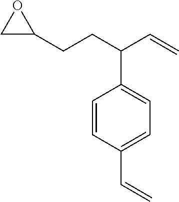 [SMILES: C=Cc1ccc(C(C=C)CCC2CO2)cc1]

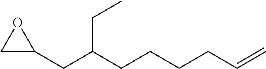

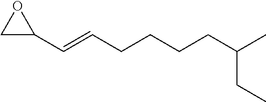

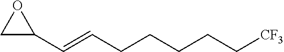 [SMILES: FC(F)(F)CCCCC/C=C/C1CO1]

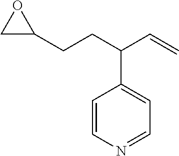

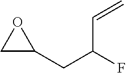

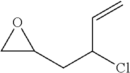

In accordance with a further preferred embodiment of the present disclosure, said second epoxy compound having general formula (III) can be selected, for example, from between 4-vinyl-1-cyclohexene 1,2-epoxide, 3,4-epoxy-1-butene, 3,4-epoxy-1-cyclohexene, allyl glycicidyl ether, glycidyl acrylate, glycidyl methacrylate, or mixtures thereof. 4-Vinyl-1-cyclohexene 1,2-epoxide is preferred.

In order to obtain, at the end of the aforesaid step i), a solution comprising the terpolymer and the catalytic system, said process can be carried out in the presence of an organic solvent.

In accordance with a preferred embodiment of the present disclosure, said step i) can be carried out in the presence of at least one organic solvent which can be selected, for example, from between aliphatic hydrocarbons such as, for example, pentane, n-heptane, octane, decane, cyclopentane or cyclohexane, or mixtures thereof; aromatic hydrocarbons such as, for example, benzene, toluene, xylene, or mixtures thereof; halogenated hydrocarbons such as, for example, dichloromethane, chloroform, carbon tetrachloride, 1,1-dichloroethane, 1,2-dichloroethane, ethyl chloride, trichloroethane, 1-chloropropane, 2-chloropropane, 1-chlorobutane, 2-chlorobutane, 1-chloro-2-methylpropane, chlorobenzene, bromobenzene, or mixtures thereof. Dichloromethane, toluene and n-heptane are preferred.

In accordance with a preferred embodiment of the present disclosure, said organic solvent can be used in volume ratio with respect to the epoxy compounds [i.e., said at least one first epoxy compound having general formula (II)+said at least one second epoxy compound having general formula (III)] of between 0:100 and 99:1, preferably between 0:100 and 90:1.

In accordance with a further preferred embodiment, the mixture of said at least one first epoxy compound having general formula (II) with said at least one second epoxy compound having general formula (III) functions as a solvent.

In accordance with a preferred embodiment of the present disclosure, in said step i), said catalytic system and the epoxy compounds [i.e., said at least one first epoxy compound having general formula (II)+said at least one second epoxy compound having general formula (III)] can be used in a molar ratio of between 1:100 and 1:100000, preferably between 1:200 and 1:10000.

In accordance with a preferred embodiment of the present disclosure, in said catalytic system, said at least one catalyst selected from complexes of a transition metal and said at least one co-catalyst selected from ionic compounds can be used in a molar ratio of between 100:1 and 1:100, preferably between 2:1 and 1:2, more preferably 1:1.

In accordance with a preferred embodiment of the present disclosure, said step i) can be carried out at a temperature of between 20° C. and 250° C., preferably between 40° C. and 160° C.

In accordance with a preferred embodiment of the present disclosure, said step i) can be carried out at a pressure of between 1 atm and 100 atm, preferably between 2 atm and 60 atm.

In accordance with a preferred embodiment of the present disclosure, said step i) can be carried out for a period of time of between 30 minutes and 36 hours, preferably between 3 hours and 30 hours.

In accordance with a preferred embodiment of the present disclosure, said sulphur-containing compound having general formula (IV) can be selected, for example, from amongst those reported in Table 2.

TABLE 2

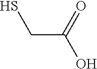

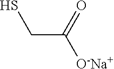

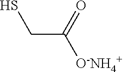

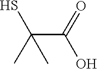

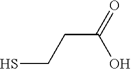

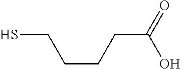

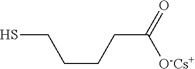

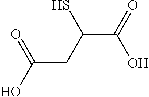

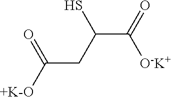

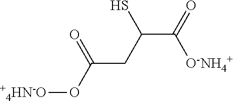

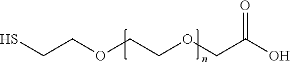

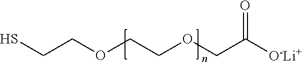

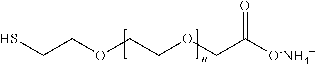

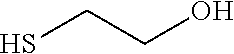

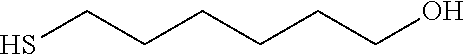

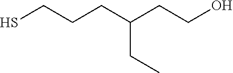

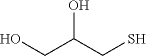

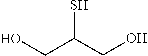

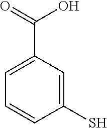

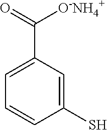

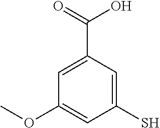

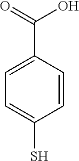

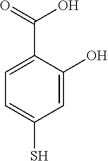 [SMILES: O=C(O)c1ccc(S)cc1O]

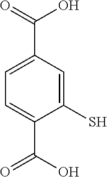 [SMILES: O=C(O)c1ccc(C(=O)O)c(S)c1]

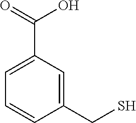 [SMILES: O=C(O)c1cccc(CS)c1]

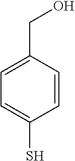

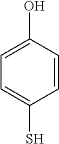

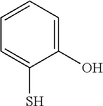

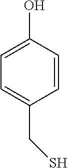

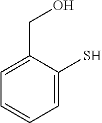

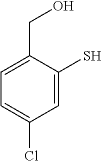

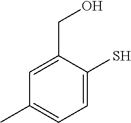

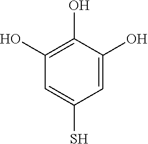

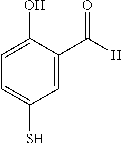

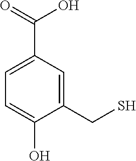 [SMILES: O=C(O)c1ccc(O)c(CS)c1]

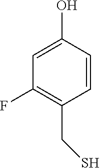

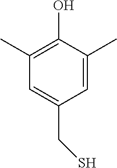

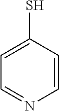

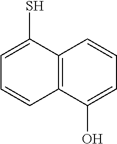 [SMILES: Oc1cccc2c(S)cccc12]

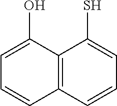 [SMILES: Oc1cccc2cccc(S)c12]

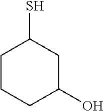

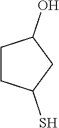

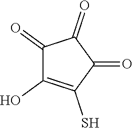

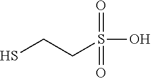

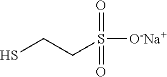

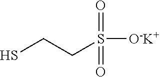

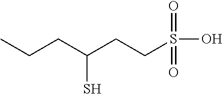

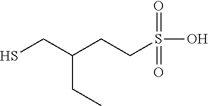

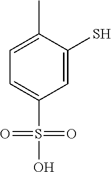

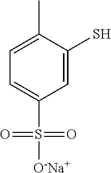

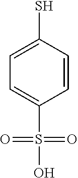 [SMILES: O=S(=O)(O)c1ccc(S)cc1]

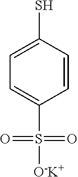

In accordance with a further preferred embodiment of the present disclosure, said sulphur-containing compound having general formula (IV) can be selected, for example, from between thioglycolic acid, thiomalonic acid, 1-thioglycerol, 2-thioglycerol, 4-mercapto benzoic acid, 2-hydroxy-4-mercapto-benzoic acid, 4-mercapto-phenol, or mixtures thereof. Thioglycolic acid is preferred.

In accordance with a preferred embodiment of the present disclosure, said step ii) can be carried out in the presence of at least one organic solvent which can be selected, for example, from between aromatic hydrocarbons such as, for example, benzene, toluene, xylene, or mixtures thereof; polar organic solvents such as, for example, acetonitrile, N,N-dimethylformamide, N-methylpyrrolidone, dimethyl sulfoxide, or mixtures thereof; ethers such as, for example, 1,2-dimethoxyethane, 1,4-dioxane, tetrahydrofuran, 2-methyl-tetrahydrofuran, or mixtures thereof. Toluene, acetonitrile, tetrahydrofuran and N,N-dimethylformamide, are preferred.

In accordance with a preferred embodiment of the present disclosure, in said step ii) said organic solvent can be used in a volume ratio with respect to said terpolymer of between 1000:1 and 1:1, preferably between 500:1 and 2:1.

In accordance with a preferred embodiment of the present disclosure, in said step ii) said sulphur-containing compound having general formula (IV) can be used in a molar ratio of between 100:1 and 1:1, preferably between 50:1 and 5:1, with respect to the vinyl groups present in the terpolymer.

In accordance with a preferred embodiment of the present disclosure, said step ii) can be carried out in the presence of at least one radical initiator such as, for example, azobisisobutyronitrile (AIBN), benzoyl peroxide, dicumyl peroxide, bis-trifluoromethyl peroxide, peracetic acid, or mixtures thereof. Azobisisobutyronitrile (AIBN) is preferred.

In accordance with a preferred embodiment of the present disclosure, in said step ii) said radical initiator can be used in a molar ratio of between 1:2 and 1:0.01, preferably between 1:1 and 1:0.1, with respect to the vinyl groups present in the terpolymer.

In accordance with a preferred embodiment of the present disclosure, said step ii) can be carried out at a temperature of between 50° C. and 200° C., preferably between 60° C. and 180° C.

In accordance with a preferred embodiment of the present disclosure, said step ii) can be carried out for a period of time of between 10 hours and 36 hours, preferably between 20 hours and 30 hours.

The process object of by the present disclosure can be carried out discontinuously (“batch”), semi-discontinuously (“semi-batch”), or continuously.

Preferably, the functionalized terpolymer obtained in accordance with the process object of the present disclosure, has a number average molecular weight (Mn) of between 5000 and 500000 and a Polydispersion Index (PDI) corresponding to the ratio between the weight average molecular weight (Mw) and the number average molecular weight (Mn) (i.e., at the ratio Mw/Mn) of between 1.1 and 5.0.

As reported above, the aforementioned process allows to obtain terpolymers which are soluble in polar solvents such as, for example, water, methanol, ethanol, butanol, acetone and dimethyl sulfoxide. Said terpolymers can be advantageously used, for example, as additives for cements.

Consequently, the present disclosure also relates to the use of a functionalized terpolymer having general formula (I) obtained through the above process, as an additive for cements.

The following list shows the reagents and materials used in the following examples of the disclosure, their possible pre-treatments and their manufacturer:
propylene oxide (Aldrich): purity 98%, distilled on calcium hydride (CaH₂) in an inert atmosphere;
4-vinyl-1-cyclohexene 1,2-epoxide (VCHO) (Aldrich): purity 98%, distilled on calcium hydride (CaH₂) in an inert atmosphere;
cyclohexene oxide (Aldrich): purity 98%, distilled on calcium hydride (CaH₂) in an inert atmosphere;
thioglycolic acid (Aldrich): 98% purity, used as it is;
dichloromethane (CH₂Cl₂) (Aldrich): kept at reflux temperature for 4 hours and distilled on calcium hydride (CaH₂);
carbon dioxide (CO₂) (Rivoira): pure, ≥99.8%, used as it is;
N,N′-bis(3,5-di-tert-butylsalicylidene)-1,2-benzodiaminochrome (III) chloride [Cr (Salaphen) Cl] obtained as described in Example 3 of the international patent application WO 2019/092266 under the name of the Applicants reported above;
N,N′-bis(3,5-di-tert-butylsalicylidene)-1,2-cyclohexanodiaminochrome (III) chloride [Cr (Salen) Cl] (Aldrich): used as it is;
tetrakis [tris (dimethylamino) phosphoranilidenamino] phosphonium chloride (PPZCl) (Aldrich): used as it is;
diethyl ether (CH₃CH₂)₂O (anhydrous) (Aldrich): pure, ≥99.7%, used as it is;
acetonitrile (CH₃CN) (anhydrous) (Aldrich): pure, ≥99.8%, used as it is;
tetrahydrofuran (THF) (anhydrous) (Aldrich): pure, ≥99.9%, used as it is;
n-heptane (anhydrous) (Aldrich): pure, 99%, used as it is;
N,N-dimethylformamide (DMF) (anhydrous) (Aldrich): pure, ≥99.8%, used as it is;
toluene (anhydrous) (Aldrich): pure, ≥99.8%, used as it is;
azobisisobutyronitrile (AIBN) (Aldrich): pure, ≥98%, used as it is;
methanol (MeOH) (anhydrous) (Aldrich): pure, 99.8%, used as it is;
hydrochloric acid in aqueous solution at 37% (Merck): used as it is;
acetone [(CH₃)₂O] (Aldrich): used as it is;
deuterated methylene chloride (CD₂Cl₂) (Merck): used as it is.

### NMR Spectra

The NMR spectra of the polymers synthesised in the following examples were acquired with a Bruker Avance 400 NMR spectrometer.

For this purpose, approximately 10 mg of the sample to be examined was dissolved in approximately 0.8 ml of CD₂Cl₂ (deuterated methylene chloride) directly in the glass tube used for the measurement. The scale of the “chemical shifts” was calibrated with respect to the dichloromethane signal set at 5.30 ppm. The experimental parameters used were the following:
128 scans;
90° impulse;
delay: 2 s, +4.5 s, of acquisition time;
spectral width: 7200 Hz.

### Thermal Analysis (DSC)

The DSC (“Differential Scanning Calorimetry”) thermal analysis, in order to determine the glass transition temperature (T_{g}) of the polymers obtained, was carried out using a Perkin Elmer Pyris differential scanning calorimeter. For this purpose, 5 mg of the polymer to be analysed were analysed, with a scanning speed between 1° C./min and 20° C./min, in an inert nitrogen atmosphere.

### Determination of the Molecular Weight

The determination of the weight average molecular weight (M_{w}) and the number average molecular weight (Mₙ), of the obtained polymers was carried out by GPC (“Gel Permeation Chromatography”), using the Waters® Alliance® GPC/V 2000 System of Waters Corporation which uses two detection lines: Refractive Index (IR) and Viscometer operating under the following conditions:
two columns: PLgel Mixed-B;
solvent/eluent: o-dichlorobenzene (Aldrich);
flow: 0.8 ml/min.;
temperature: 145° C.;
calculation of the molecular mass: Universal Calibration method.

The number average molecular weight (Mₙ), the weight average molecular weight (M_{w}) and the Polydispersion Index (PDI) (ratio M_{w}/Mₙ) are reported.

### Examples 1-9

### Synthesis of Terpolymer from Propylene Oxide, 4-vinyl-1-cyclohexene 1,2-epoxide and CO₂ [Step i)]

A 250 ml steel autoclave was cleaned with careful washing with acetone [(CH₃)₂O] and anhydrous methanol (MeOH) and subsequently kept under vacuum at 90° C., for 16 hours.

Meanwhile, in a dry box, 0.128 g (0.2 mmol) of N,N′-bis(3,5-di-tert-butyl salicylidene)-1,2-benzodiamino-chromium(III) chloride [Cr(Salaphen)Cl] and 0.079 g (0.1 mmol) of tetrakis[tris(dimethylamino)phosphoranilidenamino]phosphonium chloride (PPZCl) were weighed in a Schlenk flask and, subsequently, 5 ml of dichloromethane (CH₂Cl₂) were added: the mixture obtained was left, under stirring, at room temperature (25° C.) for 1 hour. The solvent was then removed, under vacuum, and 34.65 ml of propylene oxide (PO) (495 mmol) and 0.66 ml of 4-vinyl-1-cyclohexene 1,2-epoxide (VCHO) (5.0 mmol) were added to the catalytic system. The reaction mixture obtained was left stirring at room temperature (25° C.), for 15 minutes and subsequently placed, under vacuum, in an autoclave at a temperature of 25° C. Once placed in the autoclave, the reaction mixture was left, under stirring, for 2 minutes and, subsequently, carbon dioxide (CO₂) was introduced at a pressure of 30 atm. The system was left in saturation for 15 minutes, after which the gas inlet valve was closed. The autoclave was brought to a working temperature of 60° C. and left, under stirring, for 24 hours. At the end of the reaction, the autoclave was cooled to 30° C. and the pressure was brought to 1 atm.

The semi-solid viscous solution obtained was collected from the autoclave and purified by dissolution in dichloromethane (CH₂Cl₂) (20 ml) and precipitation with 100 ml of an anhydrous methanol (MeOH)/hydrochloric acid (HCl) solution (9/1, v/v). The precipitated solid was collected by filtration, dried under reduced pressure, at room temperature (25° C.) and finely ground.

Examples 2-9 were carried out operating under the same conditions described above with the difference relating to the use of different amounts of propylene oxide (PO) and 4-vinyl-1-cyclohexene 1,2-epoxide (VCHO). Specifically:
Example 2: 34.31 ml of propylene oxide (PO) (490 mmol) and 1.31 ml of 4-vinyl-1-cyclohexene 1,2-epoxide (VCHO) (10.0 mmol);
Example 3: 33.95 ml of propylene oxide (PO) (485 mmol) and 1.96 ml of 4-vinyl-1-cyclohexene 1,2-epoxide (VCHO) (15.0 mmol);
Example 4: 33.6 ml of propylene oxide (PO) (480 mmol) and 2.61 ml of 4-vinyl-1-cyclohexene 1,2-epoxide (VCHO) (20.0 mmol);
Example 5: 33.25 ml of propylene oxide (PO) (475 mmol) and 3.27 ml of 4-vinyl-1-cyclohexene 1,2-epoxide (VCHO) (25.0 mmol);
Example 6: 31.5 ml of propylene oxide (PO) (450 mmol) and 6.54 ml of 4-vinyl-1-cyclohexene 1,2-epoxide (VCHO) (50.0 mmol);
Example 7: 26.25 ml of propylene oxide (PO) (375 mmol) and 16.34 ml of 4-vinyl-1-cyclohexene 1,2-epoxide (VCHO) (125 mmol);
Example 8: 17.5 ml of propylene oxide (PO) (250 mmol) and 32.68 ml of 4-vinyl-1-cyclohexene 1,2-epoxide (VCHO) (250 mmol);
Example 9: 8.75 ml of propylene oxide (PO) (125 mmol) and 49.0 ml of 4-vinyl-1-cyclohexene 1,2-epoxide (VCHO) (375 mmol).

The terpolymers obtained from Examples 1-9 were then characterized by thermal analysis (DSC) (“Differential Scanning Calorimetry”) and GPC (“Gel Permeation Chromatography”): the results obtained are shown in Table 3 in which they are shown in the following order: Example number, quantity of 4-vinyl-1-cyclohexene 1,2-epoxide (VCHO) expressed as a percentage in moles with respect to the sum of the monomers [propylene oxide (PO)+4-vinyl-1-cyclohexene 1,2-epoxide (VCHO)] used in feeding, the total conversion and of the single epoxy monomers, expressed as a percentage and measured by means of NMR spectrum (¹H-NMR) on the reaction raw material so as to determine the quantity of propylene oxide (PO) and of 4-vinyl-1-cyclohexene 1,2-epoxide (VCHO) converted into polycarbonate or cyclic carbonate, the selectivity expressed as a percentage and measured by means of NMR spectrum (¹H-NMR) on the reaction raw material so as to determine the quantity of polycarbonate with respect to the cyclic carbonate, the composition of the terpolymer, i.e., the quantity of propylene carbonate units (PPC), of 4-vinyl-1-cyclohexene carbonate units (PVCHC) and of propylene oxide units (PPO), present in the terpolymer obtained after purification expressed as a percentage and measured by means of NMR spectrum (¹H-NMR), the glass transition temperature (T_{g}) in degrees centigrade, the number average molecular weight (Mₙ) in g/mole, the Polydispersion Index (PDI) (ratio M_{w}/Mₙ).

TABLE 3

| | | Total | | | | | |
|---|---|---|---|---|---|---|---|
| | | conversion | | Terpolymer | | | |
| | VCHO | [PO:VCHO] | Selectivity | [PPC]:[PVCHC]:[PPO] | T_{g} | Mₙ | PDI |
| Example | (%) | (%) | (%) | (%) | (° C.) | (g/mole) | (M_{w}/Mₙ) |
| 1 | 1 | 94 [94:99] | 68 | 89:2:9 | n.d * | 14925 | 1.6 |
| 2 | 2 | 77 [76:82] | 76 | 94:2:4 | 24 | 38085 | 1.6 |
| 3 | 3 | 82 [81:92] | 98 | 93:4:3 | 38 | 51340 | 1.4 |
| 4 | 4 | 89 [89:91] | 95 | 90:5:5 | 13 | 13420 | 1.8 |
| 5 | 5 | 93 [92:99] | 90 | 88:6:6 | 5 | 21710 | 1.6 |
| 6 | 10 | 97 [96:99] | 99 | 87:11:2 | 37 | 30310 | 1.5 |
| 7 | 25 | 96 [94:99] | 98 | 68:28:4 | 54 | 26500 | 1.2 |
| 8 | 50 | 65 [62:65] | 97 | 35:65:0 | 38 | 8040 | 2.5 |
| 9 | 75 | 23 [60:22] | 93 | n.d.* | 93 | 22800 | 1.2 |

*not determined.

### Examples 10-21

### Synthesis of Terpolymer from Cyclohexene Oxide (CHO), 4-vinyl-1-cyclohexene 1,2-epoxide (VCHO) and CO₂ [Step i)]

A 250 ml steel autoclave was cleaned with careful washing with acetone [(CH₃)₂O] and anhydrous methanol (MeOH) and subsequently kept under vacuum at 90° C., for 16 hours.

Meanwhile, in a dry box, 0.089 mg (0.14 mmol) of N,N′-bis(3,5-di-tert-butyl salicylidene)-1,2-cyclohexanodiamino-chromium(III) chloride [Cr(Salen)Cl] and 0.108 mg (0.14 mmol) of tetrakis[tris(dimethylamino)phosphoranilidenamino]phosphonium chloride (PPZCl) were weighed in a Schlenk flask and, subsequently, 5 ml of dichloromethane (CH₂Cl₂) were added: the mixture obtained was left, under stirring, at room temperature (25° C.) for 1 hour. The solvent was then removed, under vacuum, and 35.05 ml of cyclohexene oxide (CHO) (346.5 mmol) and 0.46 ml of 4-vinyl-1-cyclohexene 1,2-epoxide (VCHO) (3.5 mmol) were added to the catalytic system. The reaction mixture obtained was left, under stirring, at room temperature (25° C.), for 15 minutes and subsequently placed, under vacuum, in an autoclave at a temperature of 25° C. Once placed in the autoclave, the reaction mixture was left, under stirring, for 2 minutes and, subsequently, carbon dioxide (CO₂) was introduced at a pressure of 30 atm. The system was left in saturation for 15 minutes, after which the gas inlet valve was closed. The autoclave was then brought to the operating temperature of 80° C. and left, under stirring, for 3.5 hours. At the end of the reaction, the autoclave was cooled to 25° C. and the pressure was brought to 1 atm.

The semi-solid viscous solution obtained was collected from the autoclave and purified by dissolution in dichloromethane (CH₂Cl₂) (20 ml) and precipitation with 100 ml of an anhydrous methanol (MeOH)/hydrochloric acid (HCl) solution (9/1, v/v). The precipitated solid was collected by filtration, dried under reduced pressure, at room temperature (25° C.) and finely ground.

Examples 11-21 were carried out operating under the same conditions described above with the difference relating to the use of different amounts of cyclohexene oxide (CHO) and 4-vinyl-1-cyclohexene 1,2-epoxide (VCHO). Specifically:
Example 11: 33.63 ml of cyclohexene oxide (CHO) (332.5 mmol) and 2.29 ml of 4-vinyl-1-cyclohexene 1,2-epoxide (VCHO) (17.5 mmol);
Example 12: 31.86 ml of cyclohexene oxide (CHO) (315.0 mmol) and 4.58 ml of 4-vinyl-1-cyclohexene 1,2-epoxide (VCHO) (35.0 mmol);
Example 13: 26.55 ml of cyclohexene oxide (CHO) (262.5 mmol) and 11.44 ml of 4-vinyl-1-cyclohexene 1,2-epoxide (VCHO) (87.5 mmol);
Example 14: 26.55 ml of cyclohexene oxide (CHO) (262.5 mmol) and 11.44 ml of 4-vinyl-1-cyclohexene 1,2-epoxide (VCHO) (87.5 mmol);
Example 15: 17.70 ml of cyclohexene oxide (CHO) (175.0 mmol) and 22.88 ml of 4-vinyl-1-cyclohexene 1,2-epoxide (VCHO) (175.0 mmol);
Example 16: 8.85 ml of cyclohexene oxide (CHO) (87.5 mmol) and 34.32 ml of 4-vinyl-1-cyclohexene 1,2-epoxide (VCHO) (262.5 mmol);
Example 17: 31.86 ml of cyclohexene oxide (CHO) (315.0 mmol) and 4.58 ml of 4-vinyl-1-cyclohexene 1,2-epoxide (VCHO) (35.0 mmol);
Example 18: 31.86 ml of cyclohexene oxide (CHO) (315.0 mmol) and 4.58 ml of 4-vinyl-1-cyclohexene 1,2-epoxide (VCHO) (35.0 mmol);
Example 19: 31.86 ml of cyclohexene oxide (CHO) (315.0 mmol) and 4.58 ml of 4-vinyl-1-cyclohexene 1,2-epoxide (VCHO) (35.0 mmol);
Example 20: 31.86 ml of cyclohexene oxide (CHO) (315.0 mmol) and 4.58 ml of 4-vinyl-1-cyclohexene 1,2-epoxide (VCHO) (35.0 mmol);
Example 21 (comparative): no cyclohexene oxide, 45.76 ml of 4-vinyl-1-cyclohexene 1,2-epoxide (VCHO) (350 mmol).

The functionalized terpolymers obtained in Examples 10-20, as well as the functionalized copolymer obtained in Comparative Example 21, were then characterised by thermal analysis (DSC) (“Differential Scanning Calorimetry”) and GPC (“Gel Permeation Chromatography”): the results obtained are shown in Table 4, showing, in the following order: Example number, quantity of 4-vinyl-1-cyclohexene 1,2-epoxide (VCHO), expressed as a percentage in moles with respect to the sum of the monomers [moles of cyclohexene oxide (CHO)+moles of 4-vinyl-1-cyclohexene 1,2-epoxide (VCHO)], used in feeding, the total conversion and of the single epoxy monomers, expressed as a percentage and measured by NMR (¹H-NMR) on the reaction raw product so as to determine the quantity of cyclohexene oxide (CHO) and 4-vinyl-1-cyclohexene 1,2-epoxide (VCHO), converted into polycarbonate or cyclic carbonate, the reaction time expressed in hours, the reaction temperature expressed in ° C., the selectivity expressed as a percentage and measured by NMR spectrum (¹H-NMR) on the reaction raw material so as to determine the quantity of polycarbonate with respect to the cyclic carbonate, the composition of the terpolymer i.e. the quantity of cyclohexene carbonate units (PCHC), of 4-vinyl-1-cyclohexene carbonate units (PVCHC) and of cyclohexene oxide units (CHO), present in the terpolymer obtained after purification expressed as a percentage and measured by NMR spectrum (¹H-NMR), the glass transition temperature (T_{g}) in degrees centigrade, the number average molecular weight (Mₙ) in g/mol, the Polydispersion Index (PDI) (ratio M_{w}/Mₙ).

TABLE 4

| | | Total | | | | | | | |
|---|---|---|---|---|---|---|---|---|---|
| | | conversion | | | | Terpolymer | | | |
| | VCHO | [PO:VCHO] | t | T | Selectivity | [PCHC]:[PVCHC]:[CHO] | T_{g} | Mₙ | PDI |
| Example | (%) | (%) | hours | (° C.) | (%) | (%) | (° C.) | (g/mole) | (M_{w}/Mₙ) |
| 10 | 1 | 53 [53:99] | 3.5 | 80 | 99 | 99:1:0 | 101 | 10000 | 1.1 |
| 11 | 5 | 51 [50:75] | 3.5 | 80 | 98 | 94:6:0 | 97 | 10800 | 1.1 |
| 12 | 10 | 68 [66:95] | 3.5 | 80 | 99 | 87:13:0 | 111 | 18500 | 1.1 |
| 13 | 25 | 81 [77:92] | 3.5 | 80 | 99 | 74:26:0 | 119 | 20700 | 1.1 |
| 14 | 25 | 66 [63:76] | 3.5 | 100 | 96 | 76:24:0 | 122 | 18500 | 1.2 |
| 15 | 50 | 55 [49:62] | 3.5 | 80 | 96 | 50:50:0 | 119 | 22300 | 1.2 |
| 16 | 75 | 64 [70:61] | 3.5 | 80 | 89 | 27:73:0 | 91 | 21197 | 1.4 |
| 17 | 10 | 62 [61:79] | 10 | 80 | 96 | 89:11:0 | 121 | 17300 | 1.2 |
| 18 | 10 | 73 [62:85] | 10 | 100 | 94 | n.d. | 100 | 17300 | 1.2 |
| 19 | 10 | 65 [63:83] | 3.5 | 120 | 99 | 87:13:0 | 109 | 16550 | 1.1 |
| 20 | 10 | 64 [63:77] | 10 | 120 | 98 | N/A | 102 | 12600 | 1.1 |
| 21 | 100 | 51 [0:51] | 3.5 | 80 | 99 | 0:100:0 | 84 | 25500 | 1.2 |

*not determined.

### Examples 22-29

Functionalization Reaction of the Terpolymer [Step ii)]

1.5 g of terpolymer obtained according to Example 19, containing 1.34 mmol of vinyl groups [determined by means of NMR spectrum (¹H-NMR)], 3.9 ml (53.6 mmol) of thioglycolic acid and 80 ml of anhydrous tetrahydrofuran (THF) were placed in a 250 ml flask, maintained at an inert atmosphere. The mixture was left, under stirring, at room temperature (25° C.), for 3 hours, until the reagents were completely dissolved. Subsequently, 0.19 g (1.07 mmol) of azobisisobutyronitrile (AIBN) was added and the reaction mixture was left stirring at 70° C., for 24 hours. Subsequently, the mixture was brought back to room temperature (25° C.) and the solvent was removed under vacuum. The residue obtained was purified by dissolution with anhydrous tetrahydrofuran (THF) (40 ml) and precipitation with n-heptane (200 ml): the recovered residue was dried, at 40° C., under vacuum, for 12 hours and finely ground.

Examples 23-29 were carried out operating under the same conditions described above with the quantities of reagents and solvents specified below:
Example 23: 1.5 g of terpolymer obtained according to Example 19 (1.34 mmol of vinyl groups), 3.9 ml (53.6 mmol) of thioglycolic acid, 80 ml of anhydrous tetrahydrofuran (THF), 0.19 g (1.07 mmol) of azobisisobutyronitrile (AIBN);
Example 24: 1.5 g of terpolymer obtained according to Example 19 (1.34 mmol of vinyl groups), 3.9 ml (53.6 mmol) of thioglycolic acid, 80 ml of anhydrous tetrahydrofuran (THF), 0.24 g (1.34 mmol) of azobisisobutyronitrile (AIBN);
Example 25: 1.5 g of terpolymer obtained according to Example 19 (1.34 mmol of vinyl groups), 3.9 ml (53.6 mmol) of thioglycolic acid, 80 ml of anhydrous acetonitrile (CH3CN), 0.19 g (1.07 mmol) of azobisisobutyronitrile (AIBN);
Example 26: 1.5 g of terpolymer obtained according to Example 19 (1.34 mmol of vinyl groups), 3.9 ml (53.6 mmol) of thioglycolic acid, 80 ml of anhydrous toluene, 0.19 g (1.07 mmol) of azobisisobutyronitrile (AIBN);
Example 27: 1.5 g of terpolymer obtained in accordance with Example 19 (1.34 mmol of vinyl groups), 3.9 ml (53.6 mmol) of thioglycolic acid, 80 ml of N,N-dimethylformamide (DMF) 0.19 g (1.07 mmol) of azobisisobutyron nitrile (AIBN);
Example 28: 1.5 g of terpolymer obtained in accordance with Example 13 (2.62 mmol of vinyl groups [determined by NMR spectrum (¹H-NMR)]), 7.6 ml (104.8 mmol) of thioglycolic acid, 80 ml of anhydrous acetonitrile (CH₃CN), 0.37 g (2.1 mmol) of azobisisobutyronitrile (AIBN);
Example 29: 1.5 g of terpolymer obtained according to Example 13 (2.62 mmol of vinyl groups), 7.6 ml (104.8 mmol) of thioglycolic acid, 80 ml of toluene, 0.37 g (2.1 mmol) of azobisisobutyronitrile (AIBN).

The functionalized terpolymers obtained from Examples 22-29 were then characterised by thermal analysis (DSC) (“Differential Scanning Calorimetry”) and GPC (“Gel Permeation Chromatography”): the results obtained are shown in Table 5 in which they are shown in the following order: Example number, starting terpolymer identified by the Example number in which it was prepared, solvent, process temperature in ° C., reaction time in hours, conversion of vinyl groups into thio-derivatives, measured by NMR spectrum (¹H-NMR), glass transition temperature (T_{g}) in degrees centigrade, number average molecular weight (Mₙ) in g/mol, Polydispersion Index (PDI) (ratio M_{w}/Mₙ).

TABLE 5

| | | | | | | | Mₙ | |
|---|---|---|---|---|---|---|---|---|
| Ex- | Terpolymer | | T | T | Conv. | T_{g} | (g/ | PDI |
| ample | (Example) | Solvent | (° C.) | hours | (%) | (° C.) | mole) | M_{w}/Mₙ |
| 22 | 19 | THF | 70 | 24 | 83 | 81 | 11320 | 1.6 |
| 23 | 19 | THF | 70 | 48 | 50 | 88 | 13260 | 1.5 |
| 24 | 19 | THF | 70 | 24 | 76 | 90 | 13210 | 1.4 |
| 25 | 19 | CH₃CN | 81 | 24 | 100 | 115 | 13400 | 1.3 |
| 26 | 19 | Toluene | 110 | 24 | 100 | 60 | 18110 | 1.2 |
| 27 | 19 | DMF | 140 | 24 | 0 | — | — | — |
| 28 | 13 | CH₃CN | 81 | 24 | 98 | 76 | 16260 | 1.3 |
| 29 | 13 | Toluene | 110 | 24 | 100 | 91 | 16530 | 1.2 |

1. A process for the preparation of a functionalized terpolymer having a general formula (I): 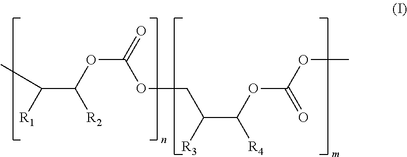
in which:
R₁ and R₂, the same or different from each other, represent a hydrogen atom; or they are selected from C₁-C₃₀ alkyl groups, preferably C₁-C₂₀, linear or branched, saturated, optionally containing heteroatoms, optionally substituted aryl groups, optionally substituted heteroaryl groups, optionally substituted cycloalkyl groups, optionally substituted heterocyclic groups;
or R₁ and R₂, can optionally be bonded together so as to form, together with the other atoms to which they are bonded, a cycle containing from 1 to 12 carbon atoms, saturated, optionally substituted with linear or branched C₁-C₂₀ alkyl groups, saturated, optionally containing heteroatoms, optionally substituted aryl groups, optionally substituted heteroaryl groups, optionally substituted cycloalkyl groups, optionally substituted heterocyclic groups, trialkyl- or triaryl-silyl groups, dialkyl- or diaryl-amino groups, dialkyl- or diaryl-phosphine groups C₁-C₂₀ alkoxy groups, preferably C₁-C₁₀, linear or branched, saturated, optionally substituted aryloxy groups, optionally substituted thioalkoxyl or thioaryloxy groups, cyano groups, said cycle optionally containing heteroatoms such as, for example, oxygen, sulphur, nitrogen, silicon, phosphorus, selenium, preferably oxygen, nitrogen;
R₃ and R₄, the same or different from each other, represent a hydrogen atom; or they are selected from C₁-C₃₀, alkyl groups, preferably C₁-C₂₀, linear or branched, saturated or unsaturated, optionally containing heteroatoms, optionally substituted aryl groups, optionally substituted heteroaryl groups, optionally substituted cycloalkyl groups, optionally substituted heterocyclic groups; provided that at least one of R₃ and R₄ is different from hydrogen and that at least one of R₃ and R₄ contains at least a double or a triple bond between two adjacent carbon atoms, and in the event that two or more double or triple bonds are present; said bonds can be conjugated or unconjugated, preferably unconjugated;
or R₃ and R₄, can optionally be bonded together so as to form, together with the other atoms to which they are bonded, a cycle containing from 1 to 12 carbon atoms, saturated or unsaturated, optionally substituted with C₁-C₂₀ alkyl groups linear or branched, saturated or unsaturated, optionally containing heteroatoms, optionally substituted aryl groups, optionally substituted heteroaryl groups, optionally substituted cycloalkyl groups, optionally substituted heterocyclic groups, trialkyl- or triaryl-silyl groups, dialkyl- or diaryl-amino groups or dialkyl- or diaryl-phosphine groups, C₁-C₂₀, alkoxyl groups, preferably C₁-C₁₀, linear or branched, saturated or unsaturated, optionally substituted aryloxy groups, optionally substituted thioalkoxyl or thioaryloxy groups, cyano groups, said cycle optionally containing heteroatoms such as, for example, oxygen, sulphur, nitrogen, silicon, phosphorus, selenium, preferably oxygen, nitrogen; provided that within the cycle or in any of its substitutions there is at least a double or a triple bond between two adjacent carbon atoms, and in the event that two or more double or triple bonds are present, said bonds may be conjugated or unconjugated, preferably unconjugated;
n and m, equal to or different from each other, are an integer between 1 and 5000, preferably between 1 and 3000, provided that n+m is greater than or equal to 5;
comprising the following steps:
i) reacting at least one first epoxy compound having a general formula (II): 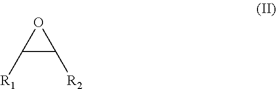
in which R₁ and R₂ have the same meanings reported above;
with at least one second epoxy compound having a general formula (III): 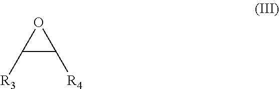
in which R₃ and R₄ have the same meanings reported above;
and carbon dioxide (CO₂), in the presence of a catalytic system comprising at least one catalyst selected from complexes of a transition metal and, optionally, at least one co-catalyst selected from ionic compounds;
wherein said at least one first epoxy compound having general formula (II) and said at least one second epoxy compound having general formula (III) are used in a molar ratio between 1:99 and 99:1, thus obtaining a terpolymer;
ii) reacting the terpolymer obtained in said step i) with at least one sulphur-containing compound having general formula (IV): 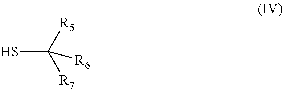
in which R₅, R₆ and R₇, the same or different from each other, represent a hydrogen atom; or they are selected from C₁-C₂₀ alkyl groups, preferably C₁-C₁₂, linear or branched, saturated or unsaturated, optionally containing heteroatoms, optionally substituted aryl groups, optionally substituted heteroaryl groups, optionally substituted cycloalkyl groups, optionally substituted heterocyclic groups;
provided that in said general formula (IV) at least one of between R₅, R₆ and R₇ differs from hydrogen and at least one of between R₅, R₆ and R₇, contains one of the following functional groups: —COOH, —COO⁻M⁺, —SO₃H, —SO₃⁻M⁺, —SO₂H, —SO₂⁻M⁺, —OPO₃H₂, —OPO₃²⁻M⁺₂, —PO₃H₂, —PO₃²⁻M⁺₂, —OH, in which M⁺ represents a monovalent inorganic cation such as, for example, cesium (Cs⁺), rubidium (Rb⁺), potassium (K⁺), lithium (Li⁺), sodium (Na⁺), copper (Cu⁺), silver (Ag⁺), ammonium (NH₄⁺) or mixtures thereof, or M⁺ represents a monovalent organic cation such as, for example, methylammonium (CH₃NH₃⁺), n-butylammonium (C₄H₁₂N⁺), ethanolammonium (C₂H₅ONH₃⁺), diethanolammonium (C₄H₁₀O₂NH₂⁺), triethanolammonium (C₆H₁₅O₃NH⁺), pyridinium (C₅H₅NH⁺), monohydroxypyridinium (C₅H₅ONH⁺), dihydroxypyridinium (C₅H₅NO₂H⁺) or mixtures thereof; preferably M⁺ is selected from between potassium (K⁺), sodium (Na⁺), ammonium (NH₄⁺) or, more preferably, ammonium (NH₄⁺).

2. The process for the preparation of a functionalized terpolymer having general formula (I) according to claim 1, wherein said catalytic system comprises:
(a) at least one catalyst selected from complexes of a transition metal having general formula (V): 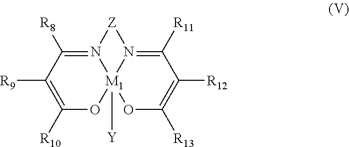
in which:
M₁ represents a metal atom selected from between chromium, manganese, iron, cobalt, nickel or aluminium, preferably chromium or cobalt;
R₈, R₉, R₁₀, R₁₁, R₁₂ and R₁₃, the same or different from each other, represent a hydrogen atom; or they are selected from C₁-C₂₀ alkyl groups, preferably C₁-C₁₂, linear or branched, saturated or unsaturated, optionally containing heteroatoms; optionally substituted aryl groups; optionally substituted heteroaryl groups; optionally substituted cycloalkyl groups; optionally substituted heterocyclic groups;
or R₉ and R₁₀ and/or R₁₂ and R₁₃, can optionally be bonded together so as to form, together with the other atoms to which they are bonded, a cycle containing from 2 to 12 carbon atoms, saturated, unsaturated, or optionally aromatic substituted with linear or branched, saturated or unsaturated C₁-C₂₀ alkyl groups, optionally containing heteroatoms, optionally substituted aryl groups, optionally substituted heteroaryl groups, optionally substituted cycloalkyl groups, optionally substituted heterocyclic groups, trialkyl- or triaryl-silyl groups, dialkyl- or diaryl-amino groups, dialkyl- or diaryl-phosphine groups, C₁-C₂₀ alkoxy groups, preferably C₂-C₁₀, linear or branched, saturated or unsaturated, optionally substituted aryloxy groups, optionally substituted thioalkoxyl or thioaryloxy groups, cyano groups, said cycle optionally containing heteroatoms such as oxygen, sulphur, nitrogen, silicon, phosphorus or selenium, preferably oxygen or nitrogen;
Y represents a halide anion such as a fluoride anion, a chloride anion, a bromide anion, an iodide anion, preferably a chloride anion, a bromide anion; or it is selected from inorganic anions such as azide anion, hydroxide anion, amide anion, perchlorate anion, chlorate anion, sulphate anion, phosphate anion, nitrate anion, preferably an azide anion; or it is selected from organic anions such as C₁-C₂₀ alcoholate anion, C₁-C₂₀ thioalcoholate anion, C₁-C₃₀ carboxylate anion, C₁-C₃₀ alkyl- or dialkyl-amide anion;
Z represents a divalent organic radical having general formula (VI), (VII) or (VIII): 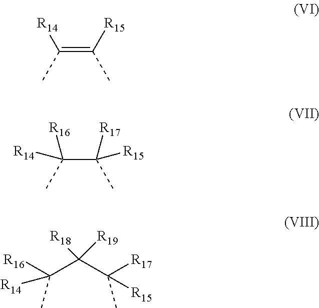
in which:
R₁₄, R₁₅, R₁₆, R₁₇, R₁₈ and R₁₉, the same or different from each other, represent a hydrogen atom; or they are selected from C₁-C₂₀ alkyl groups, preferably C₁-C₁₂, linear or branched, saturated or unsaturated, optionally containing heteroatoms; optionally substituted aryl groups; optionally substituted heteroaryl groups; optionally substituted cycloalkyl groups; optionally substituted heterocyclic groups;
or R₁₄ and R₁₅ in the general formula (VI), or R₁₅ and R₁₆ or R₁₆ and R₁₇ in the general formula (VII), or R₁₄ and R₁₈ or R₁₄ and R₁₉ or R₁₇ and R₁₉ or R₁₈ and R₁₇ in the general formula (VIII), can optionally be bonded together so as to form, together with the other atoms to which they are bonded, a cycle containing from 2 to 12 carbon atoms, saturated, unsaturated, or aromatic, optionally substituted with linear or branched, saturated or unsaturated C₁-C₂₀ alkyl groups, optionally containing heteroatoms, optionally substituted aryl groups, optionally substituted heteroaryl groups, optionally substituted cycloalkyl groups, optionally substituted heterocyclic groups, trialkyl- or triaryl-silyl groups, dialkyl- or diaryl-amino groups dialkyl- or diaryl-phosphine groups, C₁-C₂₀ alkoxy groups, preferably C₂-C₁₀, linear or branched, saturated or unsaturated, optionally substituted aryloxy groups, optionally substituted thioalkoxyl or thioaryloxy groups, cyano groups, said cycle optionally containing heteroatoms such as oxygen, sulphur, nitrogen, silicon, phosphorus or selenium, preferably oxygen or nitrogen;
(b) at least one co-catalyst selected from ionic compounds having general formula (IX): 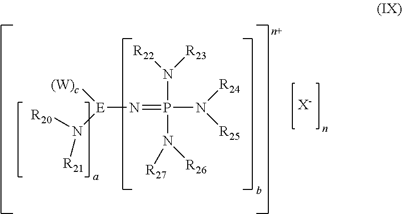
in which:
E represents an atom selected from between phosphorus, arsenic, antimony or bismuth, preferably phosphorus;
R₂₀, R₂₁, R₂₂, R₂₃, R₂₄, R₂₅, R₂₆ and R₂₇, the same or different from each other, represent a hydrogen atom; or they are selected from between C₁-C₂₀ alkyl groups, preferably C₁-C₁₂, linear or branched, saturated or unsaturated, optionally containing heteroatoms, optionally substituted aryl groups, optionally substituted heteroaryl groups, said optionally substituted heteroaryl groups being optionally in cationic form, cycloalkyl groups optionally substituted, optionally substituted heterocyclic groups, said optionally substituted heterocyclic groups being optionally in cationic form, trialkyl- or triaryl-silyl groups;
or R₂₀ and R₂₁, and/or R₂₂ and R₂₃, or R₂₃ and R₂₄, or R₂₄ and R₂₅, and/or R₂₆ and R₂₇, can optionally be bonded together so as to form, together with the other atoms to which they are bonded, a cycle containing from 2 to 12 carbon atoms, saturated, unsaturated, or aromatic, optionally substituted with linear or branched, saturated or unsaturated C₁-C₂₀ alkyl groups, optionally containing heteroatoms, optionally substituted aryl groups, optionally substituted heteroaryl groups, optionally cycloalkyl groups substituted, optionally substituted heterocyclic groups, trialkyl- or triaryl-silyl groups, dialkyl- or diaryl-amino groups, dialkyl- or diaryl-phosphine groups, C₁-C₂₀ alkoxyl groups, preferably C₂-C₁₀, linear or branched, saturated or unsaturated, optionally substituted aryloxy groups, optionally substituted thioalkoxy or thioaryloxy groups, cyano groups, said cycle optionally containing heteroatoms such as oxygen, sulphur, nitrogen, silicon, phosphorus or selenium, preferably oxygen, nitrogen;
W represents a halogen atom such as chlorine, bromine, fluorine, iodine, preferably chlorine, bromine; or it is selected from C₁-C₂₀ alkoxy groups, preferably C₂-C₁₀, linear or branched, saturated or unsaturated, optionally substituted aryloxy groups, oxylamino groups;
X⁻ represents a halide anion such as a fluoride anion, a chloride anion, a bromide anion or an iodide anion, preferably a chloride anion or a bromide anion; or it is selected from inorganic anions such as azide anion, perchlorate anion, chlorate anion, sulphate anion, phosphate anion, nitrate anion, hexafluorophosphate anion or tetrafluoroborate anion; or it is selected from organic anions such as benzenesulfonate anion, toluenesulfonate anion, dodecylsulfate anion, octylphosphate anion, dodecylphosphate anion, octadecylphosphate anion or phenylphosphate anion; or it is selected from tetraalkylborate anions optionally containing heteroatoms such as oxygen, sulphur, nitrogen, silicon, phosphorus or selenium, preferably oxygen or nitrogen; tetraarylborate anions optionally containing heteroatoms such as oxygen, sulphur, nitrogen, silicon, phosphorus or selenium, preferably oxygen or nitrogen; preferably a chloride anion or an azide anion;
a is an integer between 0 and 4, preferably between 1 and 3;
b is an integer between 0 and 4, preferably between 1 and 4;
c is 0 or 1, preferably 0;
provided that the sum of a+b+c is equal to 4 and that at least either a or b is not 0;
n is an integer between 1 and 4, preferably 1 or 2.

3. The process for the preparation of a functionalized terpolymer having general formula (I) according to claim 1, wherein said catalytic system comprises:
(c) at least one catalyst selected from complexes of a transition metal having general formula (V): 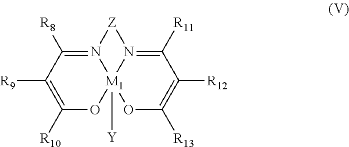
in which R₈, R₉, R₁₀, R₁₁, R₁₂, R₁₃, M₁, Z and Y, have the same meanings reported above;
(d) at least one co-catalyst selected from ionic compounds having general formula (X): 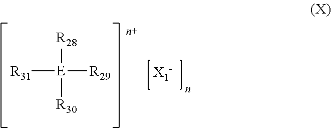
in which:
E represents a metal atom selected from between phosphorus, arsenic, antimony or bismuth, preferably phosphorus;
R₂₈, R₂₉, R₃₀ and R₃₁, the same or different from each other, represent a hydrogen atom; or they represent a halogen atom such as, for example, fluorine, chlorine, bromine, preferably fluorine or bromine; or they are selected from C₁-C₂₀ alkyl groups, preferably C₁-C₁₂, linear or branched, saturated or unsaturated, optionally containing heteroatoms, optionally substituted aryl groups, optionally substituted heteroaryl groups, said optionally substituted heteroaryl groups being optionally in cationic form, cycloalkyl groups optionally substituted, optionally substituted heterocyclic groups, said optionally substituted heterocyclic groups being optionally in cationic form;
or R₂₈ and R₂₉, or R₂₉ and R₃₀, or R₃₀ and R₃₁, or R₃₁ and R₂₈, can optionally be bonded together so as to form, together with the other atoms to which they are bonded, a cycle containing from 1 to 12 carbon atoms, saturated, unsaturated, or aromatic, optionally substituted with linear or branched C₁-C₂₀ alkyl groups, saturated or unsaturated, optionally containing heteroatoms, optionally substituted aryl groups, optionally substituted heteroaryl groups, optionally substituted cycloalkyl groups, optionally substituted heterocyclic groups, trialkyl- or triaryl-silyl groups, dialkyl- or diaryl-amino groups, dialkyl- or diaryl-phosphine groups C₁-C₂₀ alkoxy groups, preferably C₂-C₁₀, linear or branched, saturated or unsaturated, optionally substituted aryloxyl groups, thioalkoxyl or thioaryloxy groups optionally substituted, cyano groups, said cycle optionally containing heteroatoms such as oxygen, sulphur, nitrogen, silicon, phosphorus or selenium, preferably oxygen or nitrogen;
X₁⁻ represents a halide anion such as a fluoride anion, a chloride anion, a bromide anion or an iodide anion, preferably a chloride anion or a bromide anion; or it is selected from inorganic anions such as azide anion, perchlorate anion, chlorate anion, sulphate anion, phosphate anion, nitrate anion, hexafluorophosphate anion or tetrafluoroborate anion; or it is selected from organic anions such as benzenesulfonate anion, toluenesulfonate anion, dodecylsulfate anion, octylphosphate anion, dodecylphosphate anion, octadecylphosphate anion, phenylphosphate anion or tetraphenylborate anion; preferably a chloride anion, a bromide anion, an azide anion, a tetrafluoroborate anion or a sulphate anion;
provided that at least three of between R₂₈, R₂₉, R₃₀ and R₃₁, are not hydrogen.

4. The process for the preparation of a functionalized terpolymer having general formula (I) according to claim 1, wherein said catalytic system comprises:
(e) at least one catalyst selected from complexes of a transition metal having general formula (XI): 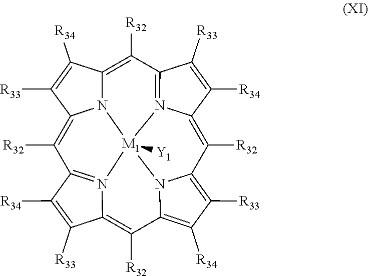
in which:
M₁ represents a metal atom selected from between chromium, manganese, iron, cobalt, nickel or aluminium, preferably chromium or cobalt;
Y₁ represents a halide anion such as a fluoride anion, a chloride anion, a bromide anion, an iodide anion; or it is selected from inorganic anions such as azide anion, hydroxide anion, amide anion, perchlorate anion, chlorate anion, sulphate anion, phosphate anion, nitrate anion; or it is selected from organic anions such as C₁-C₃₀ carboxylated anions such as acetate anion, butyrate anion, 2-ethyl-hexanoate anion, acrylate anion, methyl methacrylate anion, benzoate anion, trifluoroacetate anion, C₁-C₂₀ alcoholate anions such as, methoxide anion, ethoxide anion, tert-butoxide anion, phenoxide anion, 2,4,6-trimethylphenoxide anion 4-tert-butylphenoxide anion C₁-C₂₀ thioalcoholate anions such as thioethoxide anion, thiophenoxide anion C₁-C₃₀ alkyl- or dialkyl-amides anion such as di-methyl-amide di-iso-propylamide anion, di-phenyl-amide anion; preferably a chloride anion, a bromide anion or an azide anion;
R₃₂ represents a hydrogen atom; or it is selected from C₁-C₂₀ alkyl groups, preferably C₁-C₁₂, linear or branched, saturated or unsaturated, optionally containing heteroatoms, optionally substituted aryl groups, optionally substituted heteroaryl groups, said optionally substituted heteroaryl groups being optionally in cationic form, cycloalkyl groups optionally substituted, optionally substituted heterocyclic groups, said optionally substituted heterocyclic groups being optionally in cationic form;
R₃₃ and R₃₄, the same or different from each other, represent a hydrogen atom; or they are selected from C₁-C₂₀ alkyl groups, preferably C₁-C₁₂, linear or branched, saturated or unsaturated alkyl groups, optionally containing heteroatoms, optionally substituted aryl groups, optionally substituted heteroaryl groups, optionally substituted cycloalkyl groups, optionally substituted heterocyclic groups, trialkyl or optionally substituted triaryl silyl groups;
or R₃₃ and R₃₄, can optionally be bonded together so as to form, together with the atoms to which they are bonded, a cycle containing from 3 to 12 carbon atoms, saturated, unsaturated or aromatic, optionally polycondensed, optionally substituted with C₁-C₂₀ linear or branched, saturated or unsaturated alkyl groups, optionally containing heteroatoms, optionally substituted aryl groups, optionally substituted heteroaryl groups, optionally substituted cycloalkyl groups, optionally substituted heterocyclic groups, trialkyl- or triaryl-silyl groups, dialkyl- or diaryl-amino groups C₁-C₂₀ alkoxy groups, preferably C₂-C₁₀, linear or branched, saturated or unsaturated, optionally substituted aryloxy groups, optionally substituted thioalkoxyl or thioaryloxy groups, cyano groups, said cycle optionally containing heteroatoms such as oxygen, sulphur, nitrogen, silicon, phosphorus or selenium, preferably oxygen or nitrogen;
(f) at least one co-catalyst selected from:
(g) ionic compounds having general formula (X): 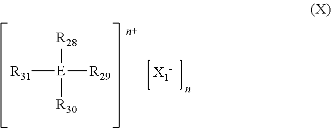
in which R₂₈, R₂₉, R₃₀, R₃₁, E and X₁⁻, have the meanings reported above;
(h) ionic compounds having general formula (IX): 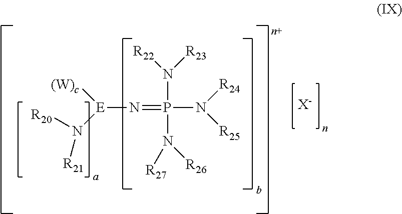
in which E, W, R₂₀, R₂₁, R₂₂, R₂₃, R₂₄, R₂₅, R₂₆, R₂₇, X⁻, a, b, c and n have the meanings reported above.

5. The process for the preparation of a functionalized terpolymer having general formula (I) according to claim 1, wherein said first epoxy compound having general formula (II) is selected from between C₂-C₂₀, alkylene oxides, optionally substituted with one or more halogen atoms or with one or more alkoxy groups; C₆-C₂₀ cycloalkylene oxides, optionally substituted with one or more halogen atoms or with one or more alkoxy groups; C₈-C₂₀ styrene oxides, optionally substituted with one or more halogen atoms or with one or more alkoxy, alkyl or aryl groups.

6. The process for the preparation of a functionalized terpolymer having general formula (I) according to claim 5, wherein said first epoxy compound having general formula (II) is selected from between ethylene oxide, propylene oxide, butene oxide, pentene oxide, hexene oxide, octene oxide, decene oxide, dodecene oxide, tetradecene oxide, hexadecene oxide, octadecene oxide, epifluorhydrin, epichlorohydrin, epibromhydrin, iso-propyl glycidyl ether, butyl glycidyl ether, tert-butyl glycidyl ether, 2-ethylhexyl glycidyl ether, cyclopentene oxide, cyclohexene oxide, cyclooctene oxide, cyclododecene oxide, α-pinene oxide, 2,3-epoxinorbornane, 2,3-epoxypropylbenzene, styrene oxide, phenylpropylene oxide, stilbene oxide, chlorostilbene oxide, dichlorostilbene oxide, 1,2-epoxy-3-phenoxypropane, benzyloxymethyl oxirane, glycidyl-methylphenyl ether, chlorophenyl-2,3-epoxypropyl ether, epoxypropyl methoxyphenyl ether, biphenyl glycidyl ether, glycidyl naphthyl ether, or mixtures thereof; preferably between cyclohexene oxide, propylene oxide, ethylene oxide.

7. The process for the preparation of a functionalized terpolymer having general formula (I) according to claim 1, wherein said second epoxy compound having general formula (III) is selected from the compounds shown in Table 1:
TABLE 1

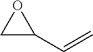

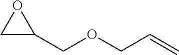

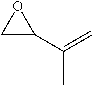

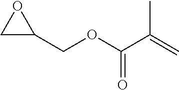

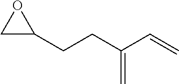

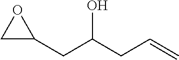

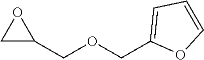 [SMILES: c1coc(COCC2CO2)c1]

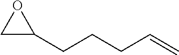

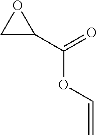

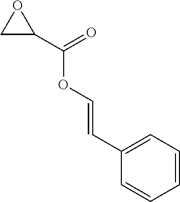 [SMILES: O=C(O/C=C/c1ccccc1)C1CO1]

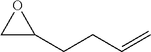

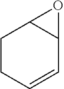

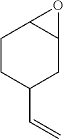

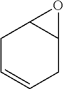

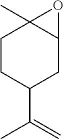

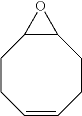

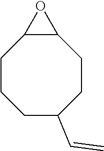

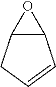

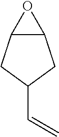

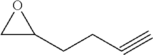

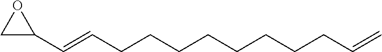

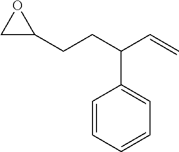

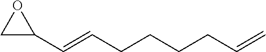

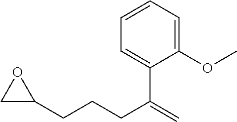 [SMILES: C=C(CCCC1CO1)c1ccccc1OC]

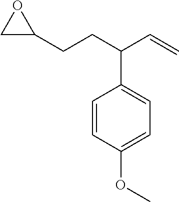 [SMILES: C=CC(CCC1CO1)c1ccc(OC)cc1]

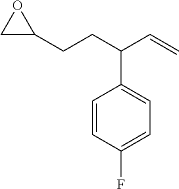

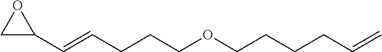

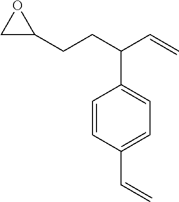 [SMILES: C=Cc1ccc(C(C=C)CCC2CO2)cc1]

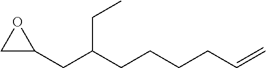

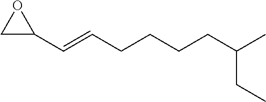

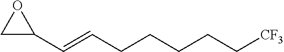 [SMILES: FC(F)(F)CCCCC/C=C/C1CO1]

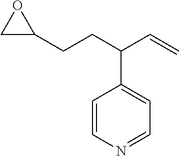

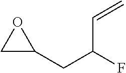

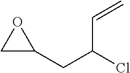

8. The process for the preparation of a functionalized terpolymer having general formula (I) according to claim 5, wherein said second epoxy compound having general formula (III) is selected from between 4-vinyl-1-cyclohexene 1,2-epoxide, 3,4-epoxy-1-butene, 3,4-epoxy-1-cyclohexene, allyl glycicidyl ether, glycidyl acrylate, glycidyl methacrylate, or mixtures thereof; preferably 4-vinyl-1-cyclohexene 1,2-epoxide.

9. The process for the preparation of a functionalized terpolymer having general formula (I) according to claim 1, in which said step i) is carried out in the presence of at least one organic solvent selected from between idrocarburi aliphatic hydrocarbons such as pentane, n-heptane, -octane, decane, cyclopentane, cyclohexane, or mixtures thereof; aromatic hydrocarbons such as benzene, toluene, xylene, or mixtures thereof; halogenated hydrocarbons such as dichloromethane, chloroform, carbon tetrachloride, 1,1-dichloroethane, 1,2-dichloroethane, ethyl chloride, trichloroethane, 1-chloropropane, 2-chloropropane, 1-chlorobutane, 2-chlorobutane, 1-chloro-2-methylpropane, chlorobenzene, bromobenzene, or mixtures thereof; preferably between dichloromethane, toluene or n-heptane.

10. The process for the preparation of a functionalized terpolymer having general formula (I) according to claim 9, wherein said organic solvent is used in volume ratio with respect to the epoxy compounds [i.e., said at least one epoxy compound having general formula (II)+said at least one second epoxy compound having general formula (III)] of between 0:100 and 99:1, preferably between 0:100 and 90:1.

11. The process for the preparation of a functionalized terpolymer having general formula (I) according to claim 9, wherein the mixture of said at least one first epoxide compound having general formula (II) with said at least one second epoxy compound having general formula (III), works as a solvent.

12. The process for the preparation of a functionalized terpolymer having general formula (I) according to claim 1, wherein in said step i) said catalytic system and the epoxy compounds [i.e., said at least one epoxy compound having general formula (II)+said at least one second epoxy compound having general formula (III)] are used in a molar ratio of between 1:100 and 1:100000, preferably between 1:200 and 1:10000.

13. The process for the preparation of a functionalized terpolymer having general formula (I) according to claim 1, wherein, in said catalytic system, said at least one catalyst selected from complexes of a transition metal and said at least one co-catalyst selected from Ionic compounds are used in a molar ratio of between 100:1 and 1:100, preferably between 2:1 and 1:2, more preferably, 1:1.

14. The process for the preparation of a functionalized terpolymer having general formula (I) according to claim 1, in which said step i) is carried out:
at a temperature of between 20° C. and 250° C., preferably between 40° C. and 160° C.; and/or
at a pressure of between 1 atm and 100 atm, preferably between 2 atm and 60 atm; and/or
for a period of time of between 30 minutes and 36 hours, preferably between 3 hours and 30 hours.

15. The process for the preparation of a functionalized terpolymer having general formula (I) according to claim 1, wherein said sulphur-containing compound having general formula (IV) is selected from those reported in Table 2:
TABLE 2

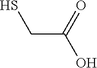

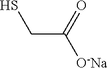

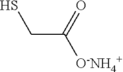

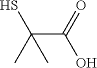

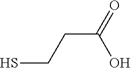

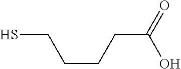

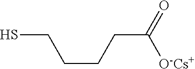

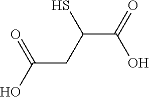

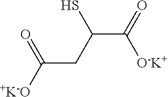

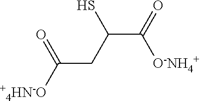

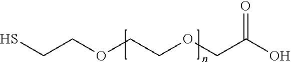

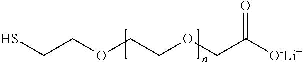

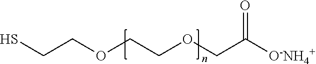

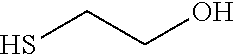

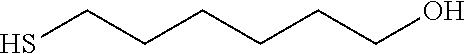

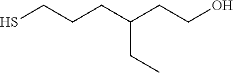

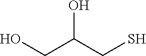

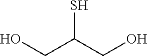

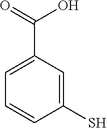

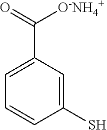

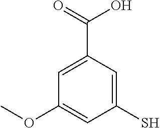

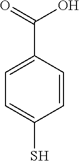

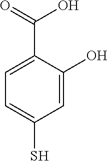 [SMILES: O=C(O)c1ccc(S)cc1O]

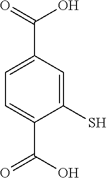 [SMILES: O=C(O)c1ccc(C(=O)O)c(S)c1]

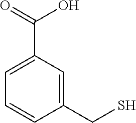 [SMILES: O=C(O)c1cccc(CS)c1]

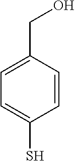

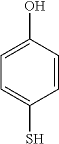

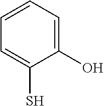

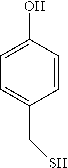

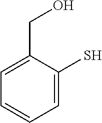

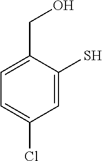

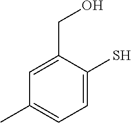

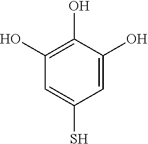

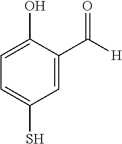

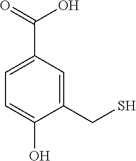 [SMILES: O=C(O)c1ccc(O)c(CS)c1]

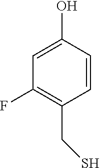

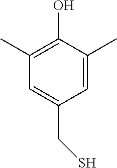

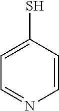

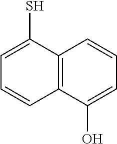 [SMILES: Oc1cccc2c(S)cccc12]

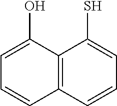 [SMILES: Oc1cccc2cccc(S)c12]

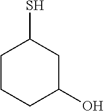

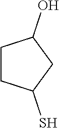

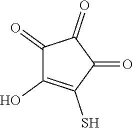

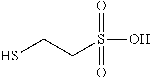

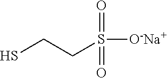

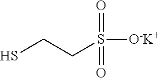

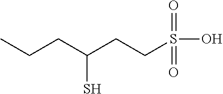

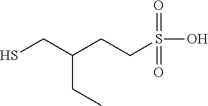

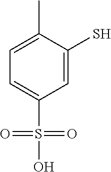

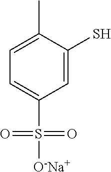

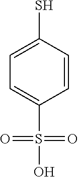 [SMILES: O=S(=O)(O)c1ccc(S)cc1]

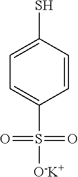

16. The process for the preparation of a functionalized terpolymer having general formula (I) according to claim 1, wherein said sulphur-containing compound having general formula (IV) is selected from between thioglycolic acid, thiomhalonic acid, 1-thioglycerol, 2-thioglycerol, 4-mercapto benzoic acid, 2-hydroxy-4-mercapto benzoic acid, 4-mercapto-phenol, or mixtures thereof; preferably thioglycolic acid.

17. The process for the preparation of a functionalized terpolymer having general formula (I) according to claim 1, in which said step ii) is carried out in the presence of at least one organic solvent which can be selected from between aromatic hydrocarbons such as benzene, toluene, xylene, or mixtures thereof; polar organic solvents such as acetonitrile, N,N-dimethylformamide, N-methylpyrrolidone, dimethyl sulfoxide, or their mixtures; ethers such as 1,2-dimethoxyethane, 1,4-dioxane, tetrahydrofuran, 2-methyl-tetrahydrofuran, or mixtures thereof, preferably between toluene, acetonitrile, tetrahydrofuran, N,N-dimethylformamide.

18. The process for the preparation of a functionalized terpolymer having general formula (I) according to claim 17, in which, in said step ii), said organic solvent is used in a volume ratio, with respect to said terpolymer, of between 1000:1 and 1:1, preferably between 500:1 and 2:1.

19. The process for the preparation of a functionalized terpolymer having general formula (I) according to claim 1, wherein in said step ii) said sulphur-containing compound having general formula (IV) is used in a molar ratio of between 100:1 and 1:1, preferably between 50:1 and 5:1, with respect to the vinyl groups present in the terpolymer.

20. The process for the preparation of a functionalized terpolymer having general formula (I) according to claim 1, in which said step ii) is carried out in the presence of at least one radical initiator such as azobisisobutyronitrile (AIBN), benzoyl peroxide, dicumyl peroxide, bis-trifluoromethyl peroxide, peracetic acid, or mixtures thereof, preferably azobisisobutyronitrile (AIBN).

21. The process for the preparation of a functionalized terpolymer having general formula (I) according to claim 1, in which, in said step ii), said radical initiator is used in a molar ratio of between 1:2 and 1:0.01, preferably between 1:1 and 1:0.1, with respect to the vinyl groups present in the terpolymer.

22. The process for the preparation of a functionalized terpolymer having general formula (I) according to claim 1, in which said step ii) is carried out:
at a temperature of between 50° C. and 200° C., preferably between 60° C. and 180° C.; and/or
for a period of time of between 10 hours and 36 hours, preferably between 20 hours and 30 hours.

23. Use of a functionalized terpolymer having general formula (I) obtained by the process according to claim 1, as an additive for cements.
